(19) United States
(12) Patent Application Publication
(10) Pub. No.: US 2024/0237034 A1
(43) Pub. Date: Jul. 11, 2024

(54) IMPROVED PRE-COLLISION SIGNALING TIMELINE

(71) Applicant: QUALCOMM Incorporated, San Diego, CA (US)

(72) Inventors: Tien Viet NGUYEN, Bridgewater, NJ (US); Sourjya DUTTA, San Diego, CA (US); Hui GUO, Beijing (CN); Gabi SARKIS, San Diego, CA (US); Shuanshuan WU, San Diego, CA (US); Kapil GULATI, Belle Mead, NJ (US)

(21) Appl. No.: 18/559,531

(22) PCT Filed: Jul. 29, 2021
(86) PCT No.: PCT/CN2021/109152

§ 371 Date: Nov. 7, 2023

(51) Int. Cl. H04W 72/40; H04W 72/044; H04W 74/0808

(52) U.S. Cl. CPC H04W 72/40; H04W 72/0473; H04W 74/0825

(57) ABSTRACT

The apparatus may be a first device at a first UE. The first device may be the first UE itself. The first UE may be configured to receive, from a second UE, a first reservation of an SL resource for a first SL transmission. The first UE may further be configured to receive, from a third UE, a second reservation of the SL resource for a second SL transmission within a threshold amount of time following the receipt of the first reservation. The first UE may also be configured to transmit a collision indication based on a collision parameter, the collision parameter being based on reception of the first reservation and the second reservation within the threshold amount of time.

### TECHNICAL FIELD

The present disclosure relates generally to communication systems, and more particularly, to sidelink (SL) communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first device at a first user equipment (UE). The first device may be a processor and/or modem at the first UE or the first UE itself. The first UE may be configured to receive, from a second UE, a first reservation of an SL resource for a first SL transmission. The first UE may further be configured to receive, from a third UE, a second reservation of the SL resource for a second SL transmission within a threshold amount of time following the receipt of the first reservation. The first UE may also be configured to transmit a collision indication based on a collision parameter, the collision parameter being based on reception of the first reservation and the second reservation within the threshold amount of time.

In another aspect of the disclosure, a method, a computer-readable medium, and an apparatus are provided. The apparatus may be a processor and/or modem at a second UE or the second UE itself. The apparatus UE may be configured to transmit an SL reservation for a SL resource, transmit an indication of a capability to receive an expected (or potential) conflict indication, and receive an expected (or potential) conflict indication from a first UE based on the transmitted SL reservation and the indication of the capability to receive an expected (or potential) conflict indication.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 illustrates example aspects of a sidelink slot structure.

FIG. 3 is a diagram illustrating an example of a first device and a second device involved in wireless communication based, e.g., on sidelink.

FIG. 4 illustrates example aspects of sidelink communication between devices, in accordance with aspects presented herein.

FIG. 5 illustrates examples of resource reservation for sidelink communication.

FIG. 6 is a diagram of a timeline for a sensing-based resource selection.

FIG. 7 is a diagram illustrating an example of a set of UEs associated with a conflict between transmissions from different UEs.

FIG. 8 is a diagram illustrating a timeline for using inter UE coordination to inform a second UE of an SL resource reservation for a particular resource.

FIG. 9 is a set of diagrams illustrating a timeline for transmitting an expected/potential conflict indication based on a pair of reservations for a same SL resource received from two different UEs.

FIG. 10 is a set of diagrams illustrating a timeline for transmitting a post-collision indication based on a pair of conflicting or colliding SL transmission from two different UEs.

FIG. 11 is a diagram illustrating an example association between PSSCH resource pools, a set of PSFCH resource pools for transmitting and/or receiving HARQ feedback, and a set of expected/potential conflict indication resource pools.

FIG. 12 is a diagram illustrating a set of subchannels associated with a PSFCH and expected/potential conflict indication symbols.

FIG. 13 is a call flow diagram illustrating a set of UEs being configured with a periodicity of expected/potential conflict indication resource pools and a minimum time gap between a reception of a first transmission and a transmission of an expected/potential conflict indication based on the received transmission.

FIG. 14 is a diagram illustrating that PSFCH resource pools and expected/potential conflict (and/or post-collision) resource pools in a combined set of PSFCH and expected/potential conflict indication resource pools may be associated with different slots in a same subchannel.

FIG. 15 is a diagram including diagrams illustrating different configurations of PSFCH resource pools and expected/potential conflict indication resource pools and expected/potential conflict indication resource pools.

FIG. 16 is a call flow diagram illustrating a UE receiving SL resource reservations, determining that the SL resource reservations conflict or collide, and transmitting expected/potential conflict conflict indications.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a diagram illustrating an example of a hardware implementation for an example apparatus.

### DETAILED DESCRIPTION

In some aspects of SL communication, devices (e.g., UEs, vehicles, etc.) may autonomously select resources for transmitting SL data. In some instances, UEs may communicate with each other to reserve SL resources for future SL transmissions. At times, collisions may occur between resources reserved by different UEs. Collisions may occur for any of various reasons. As one example, two UEs may be too far apart to receive (or consider relevant) a reservation made by the other UE, but may be close enough that a third UE may receive the SL transmission via the resources reserved by the two UEs. If the two UEs reserve a same SL resource, a conflict or collision may occur and the third UE may not be able to decode either transmission due to the interference. In other examples, one UE may miss, or fail to successfully receive a resource reservation from another UE, yet a third UE may receive the reservation and detect a collision, e.g., an overlap in time and/or frequency between the two reservations. Accordingly, a method for identifying and indicating, by the third UE, collisions or conflicts before they occur is beneficial. Improvements to the sensitivity of the collision detection under different conditions and the reaction time for detecting and indicating a collision are provided herein.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

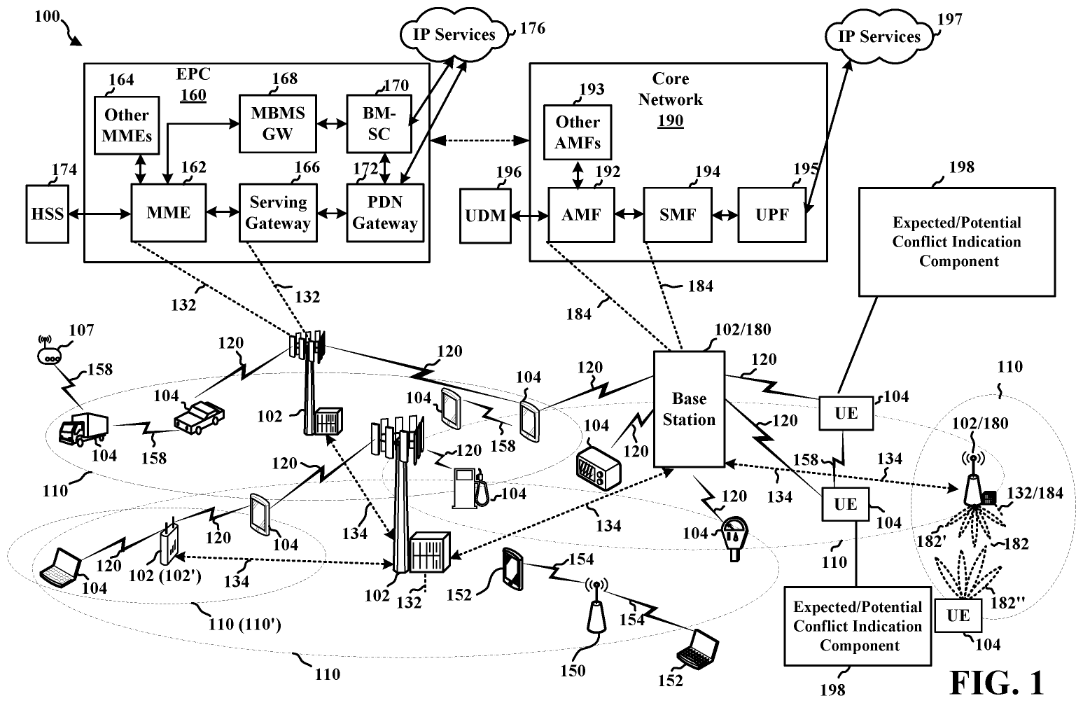

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

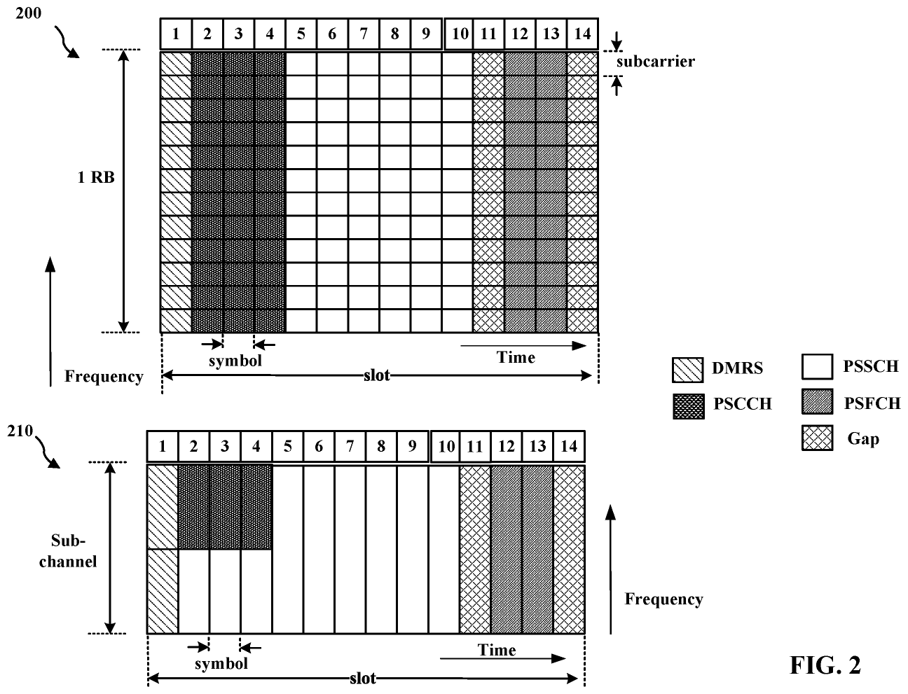

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

Referring again to FIG. 1, in certain aspects, a UE 104, or other device communicating based on sidelink, may include an expected/potential conflict indication component 198 configured to receive, from a second UE, a first reservation of an SL resource for a first SL transmission; receive, from a third UE, a second reservation of the SL resource for a second SL transmission within a threshold amount of time following the receipt of the first reservation; transmit a collision indication based on a collision parameter, the collision parameter being based on reception of the first reservation and the second reservation within the threshold amount of time. In some aspects, the expected/potential conflict indication component 198 may be configured to transmit an SL reservation for an SL resource, transmit an indication of a capability to receive an expected/potential conflict indication, and receive an expected/potential conflict indication from a first UE based on the transmitted SL reservation and the indication of the capability to receive an expected/potential conflict indication. In some aspects, the expected/potential conflict indication component 198 may be configured to configure a periodicity of an expected/potential conflict indication resource, configure a minimum time gap for expected/potential conflict indication that is different from a minimum time gap for feedback, receive a reservation for an SL resource that reserves a same SL resource as a previously received reservation for an SL resource, and transmit an expected/potential conflict indication on an expected/potential conflict indication resource following the received reservation for the SL resource by at least the minimum time gap based on receiving the reservation for the SL resource

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHZ). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming. Similarly, beamforming may be applied for sidelink communication, e.g., between UEs.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same. Although this example is described for the base station 180 and UE 104, the aspects may be similarly applied between a first and second device (e.g., a first and second UE) for sidelink communication.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. A numerology defines a subcarrier spacing (SCS) and, effectively, the symbol length/duration, which is equal to 1/SCS. The symbol length/duration is inversely related to the subcarrier spacing.

Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 12, 15, 20, 25, 50, 75, or 100 PRBs, for example. The resources for a sidelink transmission may be selected from a resource pool including one or more subchannels. As a non-limiting example, the resource pool may include between 1-27 subchannels. A PSCCH size may be established for a resource pool, e.g., as between 10-100% of one subchannel for a duration of 2 symbols or 3 symbols. The diagram 210 in FIG. 2 illustrates an example in which the PSCCH occupies about 50% of a subchannel, as one example to illustrate the concept of PSCCH occupying a portion of a subchannel. The physical sidelink shared channel (PSSCH) occupies at least one subchannel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

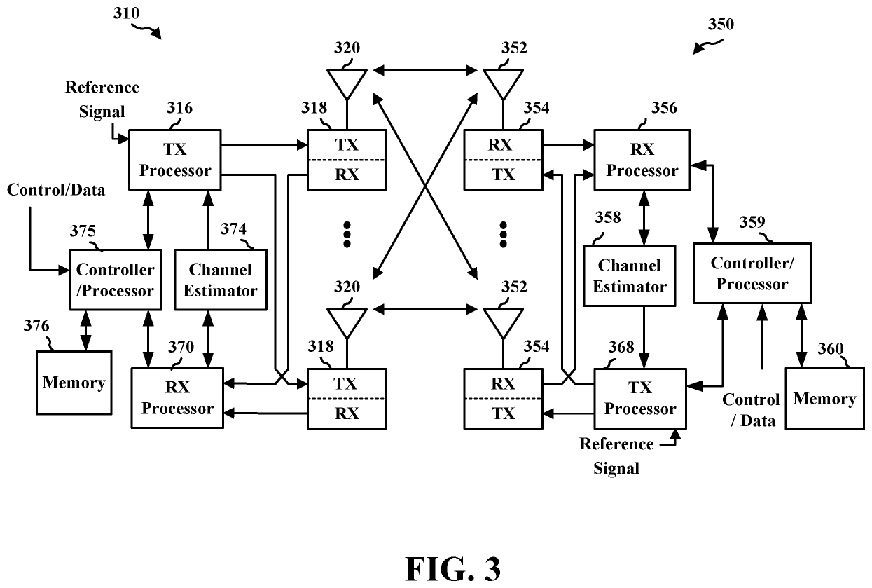

FIG. 3 is a block diagram 300 of a first wireless communication device 310 in communication with a second wireless communication device 350. The communication may be based on sidelink or an access link. In some examples, the devices 310 and 350 may communicate based on sidelink such as V2X or other D2D communication. In other aspects, the devices 310 and 350 may communication over an access link based on uplink and downlink transmissions. The communication may be based on sidelink using a PC5 interface (e.g., between two UEs). The communication may be based on an access link using a Uu interface (e.g., between a base station and a UE). The devices 310 and the 350 may comprise a UE, an RSU, a base station, etc. In some implementations, the device 310 may correspond to a base station and the device 350 may correspond to a UE. In other implementations Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318 TX. Each transmitter 318 TX may modulate a radio frequency (RF) carrier with a respective spatial stream for transmission.

At the device 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354 TX. Each transmitter 354 TX may modulate an RF carrier with a respective spatial stream for transmission.

The transmission is processed at the device 310 in a manner similar to that described in connection with the receiver function at the device 350. Each receiver 318 RX receives a signal through its respective antenna 320. Each receiver 318 RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 198 of FIG. 1.

In some aspects of SL communication, devices (e.g., UEs, vehicles, etc.) autonomously select resources for transmitting SL data. In some instances, UEs communicate with each other to reserve SL resources for future SL transmissions. While the UEs may communicate their resource reservations, two UEs may be too far apart to receive (or consider relevant) a reservation made by the other UE, but may be close enough that a third UE may receive the SL transmission via the resources reserved by the two UEs. If the two UEs reserve a same SL resource, a conflict or collision may occur and the third UE may not be able to decode either transmission due to the interference. Accordingly, a method for identifying an indicating, by the third UE, collisions or conflicts before they occur is beneficial. Improvements to the sensitivity of the collision detection under different conditions and the reaction time for detecting and indicating a collision are provided herein.

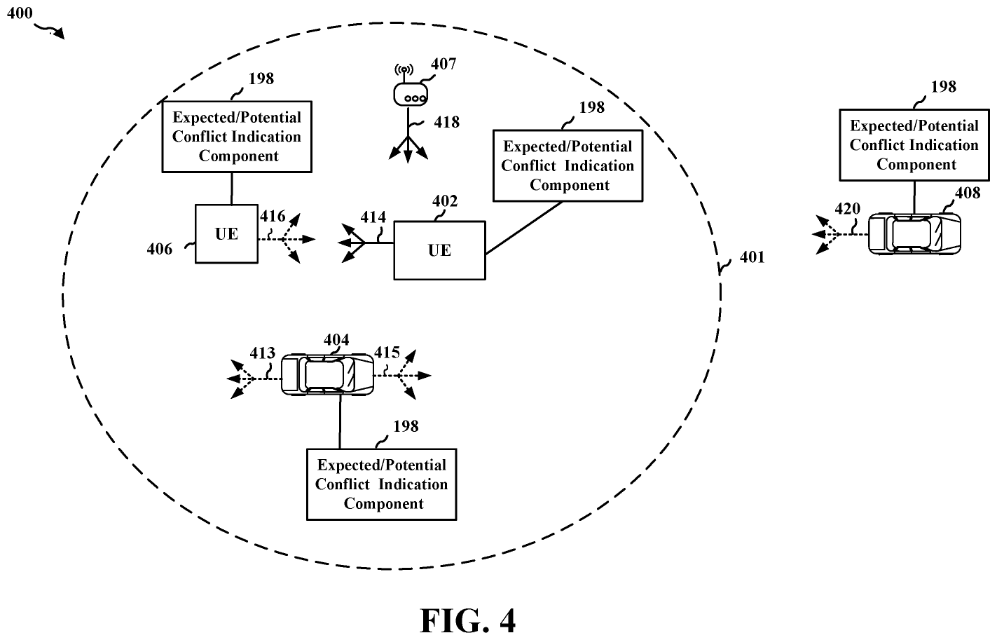

FIG. 4 illustrates an example 400 of sidelink communication between devices. The communication may be based on a slot structure comprising aspects described in connection with FIG. 2. For example, the UE 402 may transmit a sidelink transmission 414, e.g., comprising a control channel (e.g., PSCCH) and/or a corresponding data channel (e.g., PSSCH), that may be received by UEs 404, 406, 408. A control channel may include information (e.g., sidelink control information (SCI)) for decoding the data channel including reservation information, such as information about time and/or frequency resources that are reserved for the data channel transmission. For example, the SCI may indicate a number of subchannels that will be occupied by the data transmission. The SCI, in some aspects, indicates a number of TTIs, as well as the subchannels (e.g., RBs) that will be occupied by the data transmission. The SCI may also be used by receiving devices to avoid interference by refraining from transmitting on the reserved resources. The UEs 402, 404, 406, 408 may each be capable of sidelink transmission in addition to sidelink reception. Thus, UEs 404, 406, 408 are illustrated as transmitting sidelink transmissions 413, 415, 416, 420. The sidelink transmissions 413, 414, 415, 416, 420 may be unicast, broadcast or multicast to nearby devices. For example, UE 404 may transmit communication 413, 415 intended for receipt by other UEs within a range 401 of UE 404, and UE 406 may transmit communication 416. Additionally, or alternatively, RSU 407 may receive communication from and/or transmit communication 418 to UEs 402, 404, 406, 408. One or more of the UEs 402, 404, 406, 408 or the RSU 407 may comprise an expected/potential conflict indication component 198 as described in connection with FIG. 1.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

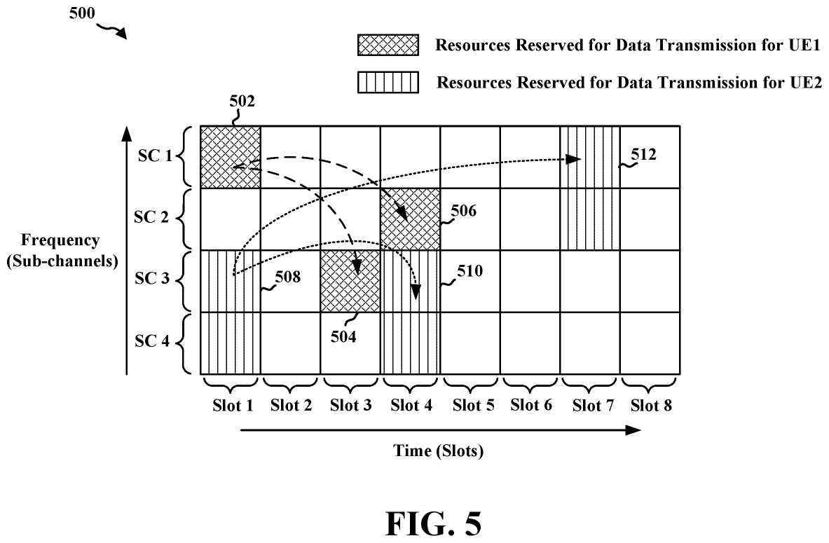

FIG. 5 is an example 500 of time and frequency resources showing reservations for sidelink transmissions. The resources may be comprised in a sidelink resource pool, for example. The resource allocation for each UE may be in units of one or more sub-channels in the frequency domain (e.g., sub-channels SC1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as shown in example 500, which provides 32 available resource blocks in total. This window may also be referred to as a resource selection window.

A first UE (“UE1) may reserve a sub-channel (e.g., SC 1) in a current slot (e.g., slot 1) for its initial data transmission 502, and may reserve additional future slots within the window for data retransmissions (e.g., 504 and 506). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 5 illustrates that a second UE (“UE2”) reserves resources in sub-channels SC 3 and SC 4 at time slot 1 for its current data transmission 508, and reserve first data retransmission 510 at time slot 4 using sub-channels SC 3 and SC 4, and reserve second data retransmission 512 at time slot 7 using sub-channels SC 1 and SC 2 as shown by FIG. 5. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 5 illustrates resources being reserved for an initial transmission and two retransmissions, the reservation may be for an initial transmission and a single transmission or only for an initial transmission.

The UE may determine an associated signal measurement (such as reference signal received power (RSRP)) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, in a first step, the UE may determine a set of candidate resources (e.g., by monitoring SCI from other UEs and removing resources from the set of candidate resources that are reserved by other UEs in a signal for which the UE measures an RSRP above a threshold value). In a second step, the UE may select N resources for transmissions and/or retransmissions of a TB. As an example, the UE may randomly select the N resources from the set of candidate resources determined in the first step. In a third step, for each transmission, the UE may reserve future time and frequency resources for an initial transmission and up to two retransmissions. The UE may reserve the resources by transmitting SCI indicating the resource reservation. For example, in the example in FIG. 5, the UE may transmit SCI reserving resources for data transmissions 508, 510, and 512.

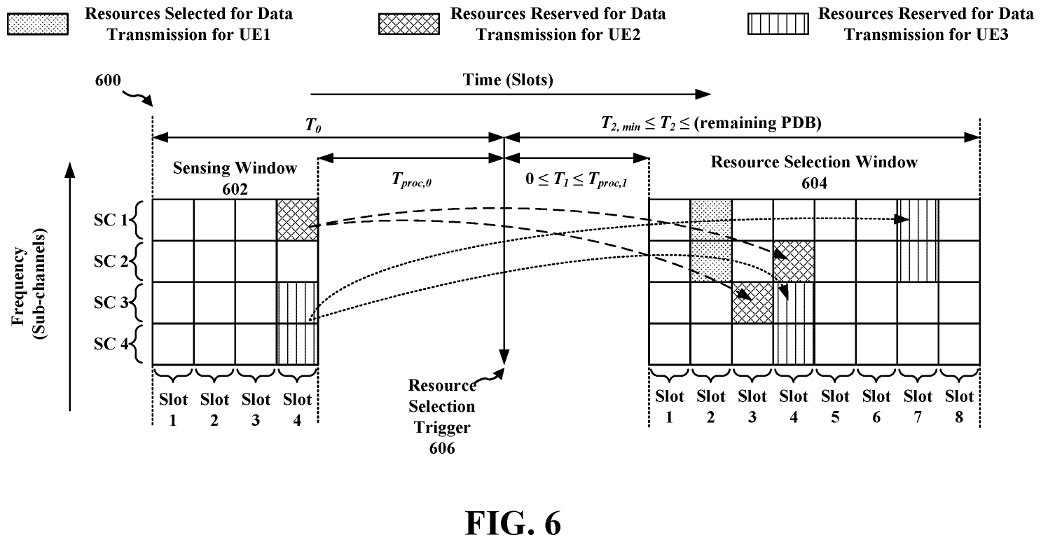

FIG. 6 is a diagram 600 of a timeline for a sensing-based resource selection. For example, the UE may sense and decode the SCI received from other UEs during a sensing window 602, e.g., a time duration prior to resource selection. Based on the sensing history during the sensing window, the UE may be able to maintain a set of available candidate resources by excluding resources that are reserved by other UEs from the set of candidate resources. A UE may complete a resource selection from its set of available candidate resources at resource selection trigger 606 at a time T_{proc,0} after the end of the sensing window 602 and transmits SCI reserving the selected resources for sidelink transmission (e.g., a PSSCH transmission) in the resource selection window 604 by the UE. There may be a time gap between the UE's selection of the resources and the UE transmitting SCI reserving the resources.

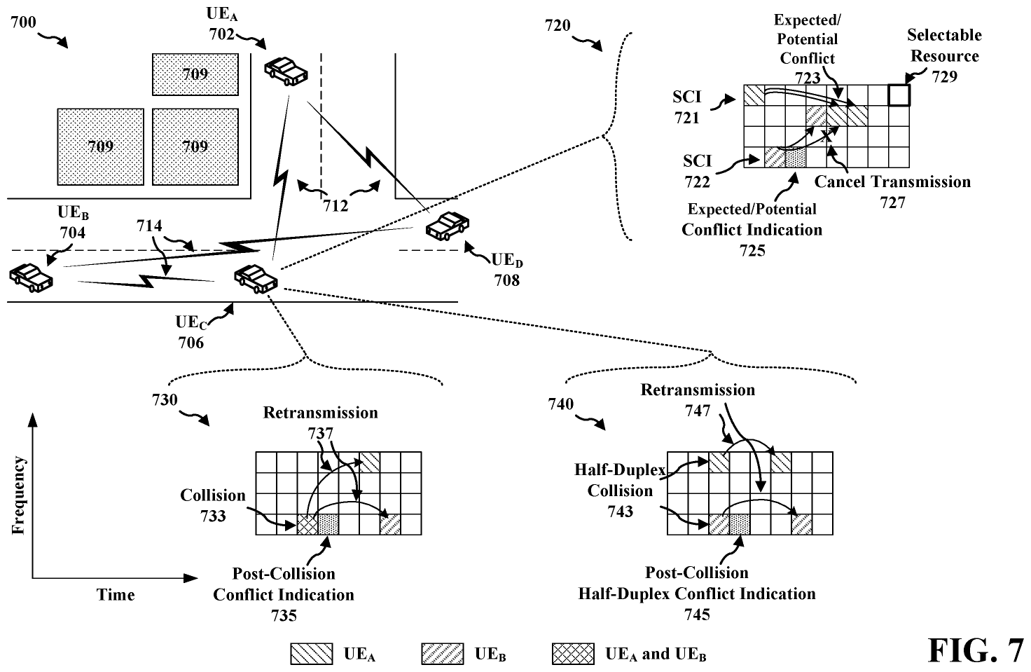

FIG. 7 is a diagram 700 illustrating an example of a set of UEs 702-706 associated with a conflict between transmissions from different UEs. Diagram 700 illustrates a set of UEs (vehicles UE_{A}-UE_{D} 702-708) associated with a conflict between a transmission of UE_{A} 702 and a transmission of UE_{B} 704. In the example of diagram 700, direct communication between UE_{A} 702 and UE_{B} 704 is blocked by obstructions 709 (e.g., buildings) (e.g., UE_{A} 702 is a hidden node for UE_{B} 704 and UE_{B} 704 is a hidden node for UE_{A} 702). However, in the example of FIG. 7, UE_{A} 702 and UE_{B} 704 transmit transmissions 712 and 714, respectively, that are received by UE_{C} 706 and possibly UE_{D} 708 and other UEs not shown. Additionally, UE_{C} 706 may determine that the transmissions 712 and 714 of UE_{A} 702 and UE_{B} 704, respectively, are either relevant to at least one other UE (e.g., UE_{C} 706, UE_{D} 708, or other UEs within a certain distance) or to each other to determine that the conflict should be addressed.

Diagrams 720-740 illustrate examples of conflicting (colliding) transmissions 712 and 714 received from UE_{A} 702 and UE_{B} 704. Diagram 720 illustrates that UE_{C} 706 may receive SL control information (SCI) 721 and 722 transmitted by UE_{A} 702 and UE_{B} 704, respectively. Each grid of diagrams 720-740 represents a resource grid. As illustrated each block is identified as a selectable resource 729 (e.g., time-and-frequency resources, a subchannel (e.g., an RB or some other grouping of resources)). The SCI 721 and 722 transmitted by UE_{A} 702 and UE_{B} 704, as shown, each include resource reservation information for two reserved time-and-frequency resources including a set of time-and-frequency resources overlapping in time and frequency (e.g., in the selectable resource identified as an expected/potential conflict 723). As will be discussed below in relation to diagram 740 a conflict between SL transmissions for UEs performing half-duplex communication may be based on resource reservation information for a set of time-and-frequency resources overlapping in time but not frequency that may be included in SCI transmitted by UE_{A} 702 and UE_{B} 704 (not shown).

Based on the SCI 721 and 722. UE_{C} 706 may detect the expected/potential conflict 723 before UE_{A} 702 and UE_{B} 704 transmit the data in the overlapping set of time-and-frequency resources. As will be discussed below, the detection may also include measuring at least one of a reference signal received power (RSRP) for each of the transmissions 712 and 714 from UE_{A} 702 and UE_{B} 704, respectively, or measuring a reference signal received quality (RSRQ) for at least one of the transmissions 712 and 714 from UE_{A} 702 and UE_{B} 704, respectively. As will be discussed below, the detection may further include determining at least one of (1) an absolute value or magnitude of an RSRP difference or ratio between the transmissions 712 and 714 from UE_{A} 702 and UE_{B} 704, respectively, or (2) a measured RSRQ for at least one of the transmissions from UE_{A} 702 and UE_{B} 704. For a first example, if UE_{C} 706 measures RSRPs for transmissions 712 and 714 as −80 dBm and −83 dBm and an absolute RSRP difference threshold for identifying conflicts is 10 dB (representing approximately a ten-fold difference in signal strengths), the transmissions 712 and 714 would be determined to be conflicting based on the absolute RSRP difference of 3 dB (representing approximately a two-fold difference). However, if UE_{C} 706 measures RSRPs for transmissions 712 and 714 as −80 dBm and −93 dBm (i.e., an absolute RSRP difference of 10 dBm, representing an approximately twenty-fold difference in signal strength) and the absolute RSRP difference threshold for identifying conflicts is 10 dBm, the transmissions 712 and 714 would be determined to not be conflicting. In some aspects, UE_{C} 706 measures an RSRQ for at least one of transmissions 712 and 714 and applies an RSRQ threshold for identifying conflicts of 0.95 (representing a ratio of 0.95 between an RSRP for the reference signal for the measured transmission and a received signal strength indicator (RSSI) (a measure of total received wide-band power) measured at the UE) to determine whether the transmissions 712 and 714 conflict.

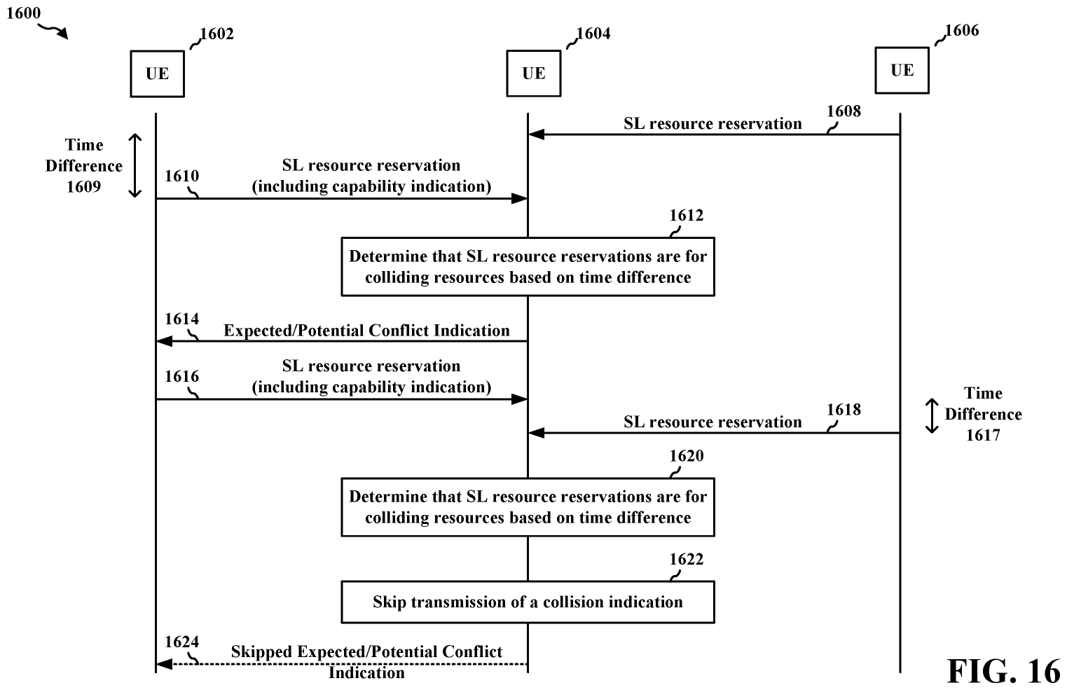

As will be further discussed below in relation to FIG. 16, in some aspects the detection may further include determining a time difference between the transmission and/or reception of SCI 721 and SCI 722 and selecting a relative power threshold (e.g., an RSRP difference magnitude threshold, an RSRQ threshold, an RSRP difference threshold range) to apply to the received SCI 721 and SCI 722 from a set of two or more relative power thresholds based on the determined time difference. The selected relative power threshold (e.g., a relative power threshold range) may be applied to the received SCI 721 and SCI 722 to determine to transmit, or not to transmit, an expected/potential conflict indication (EPCI) to one or more of the UEs (e.g., UE_{A} 702 and UE_{B} 704) transmitting the SCI (e.g., SCI 721 and SCI 722).

Based on a detected potential conflict, or collision (e.g., for resource identified as potential conflict 723), UE_{C} 706 may transmit, to at least one of UE_{A} 702 and UE_{B} 704, an expected/potential conflict indication 725. The expected/potential conflict indication 725 may be transmitted to UE_{B} 704 and may include information regarding the resources reserved by UE_{A} 702 (e.g., the reserved resources or at least the overlapping resources) or may indicate a collision associated with the SCI (e.g., SCI 722) transmitted by UE_{B} 704. UE_{B} 704 may receive the expected/potential conflict indication 725 and determine to cancel the transmission 727 in the set of time-and-frequency resources overlapping with the transmission from UE_{A} 702 (e.g., in the time-and-frequency resource identified as a potential conflict 723). The data meant to be transmitted during the set of overlapping time-and-frequency resource may then be transmitted based on per-packet scheduling.

Diagram 730 illustrates that UE_{C} 706 may receive conflicting (colliding) transmissions at a time-and-frequency resource identified as including a collision 733. Based on receiving the conflicting (colliding) transmissions, UE_{C} 706 may transmit a post-collision indication 735. The post-collision indication 735 may be transmitted to UE_{A} 702 and UE_{B} 704 and may include information indicating that at least one of (1) RSRPs measured at UE_{C} 706 or (2) at least one RSRQ measured at UE_{C} 706 indicate a conflict between the transmissions 712 and 714. UE_{A} 702 and UE_{B} 704 may receive the post-collision indication 735 and determine to re-transmit 737 the colliding transmissions. Since the re-transmission resource is selected by each of UE_{A} 702 and UE_{B} 704 based on different information or input (e.g., a randomly generated value, or a UE-specific value) it is unlikely for there to be a subsequent collision, but in the event that a collision occurs on the re-transmission, the same process may be repeated.

Diagram 740 illustrates that UE_{C} 706 may receive conflicting (colliding) transmissions at different time-and-frequency resources at a same time, the conflicting resources identified as including a half-duplex collision 743. The conflict illustrated in diagram 740 is based on an overlap in transmission time that prevents UE_{A} 702 and UE_{B} 704 from receiving the transmission from UE_{B} 704 and UE_{A} 702, respectively (e.g., because they are operating in a half-duplex mode). Based on transmissions associated with the half-duplex collision 743, UE_{C} 706 may transmit a post-collision half-duplex conflict indication 745. The post-collision half-duplex conflict indication 745 may be transmitted to UE_{A} 702 and UE_{B} 704 and may include information indicating that UE A and UE B cannot receive data from each other. UE_{A} 702 and UE_{B} 704 may receive the post-collision half-duplex conflict indication 745 and determine to re-transmit 747 the colliding transmissions. Since the re-transmission resource is selected by each of UE_{A} 702 and UE_{B} 704 based on different information or input (e.g., a randomly generated value, or a UE-specific value) it is unlikely for there to be a subsequent collision, but in the event that a collision occurs on the re-transmission, the same process may be repeated.

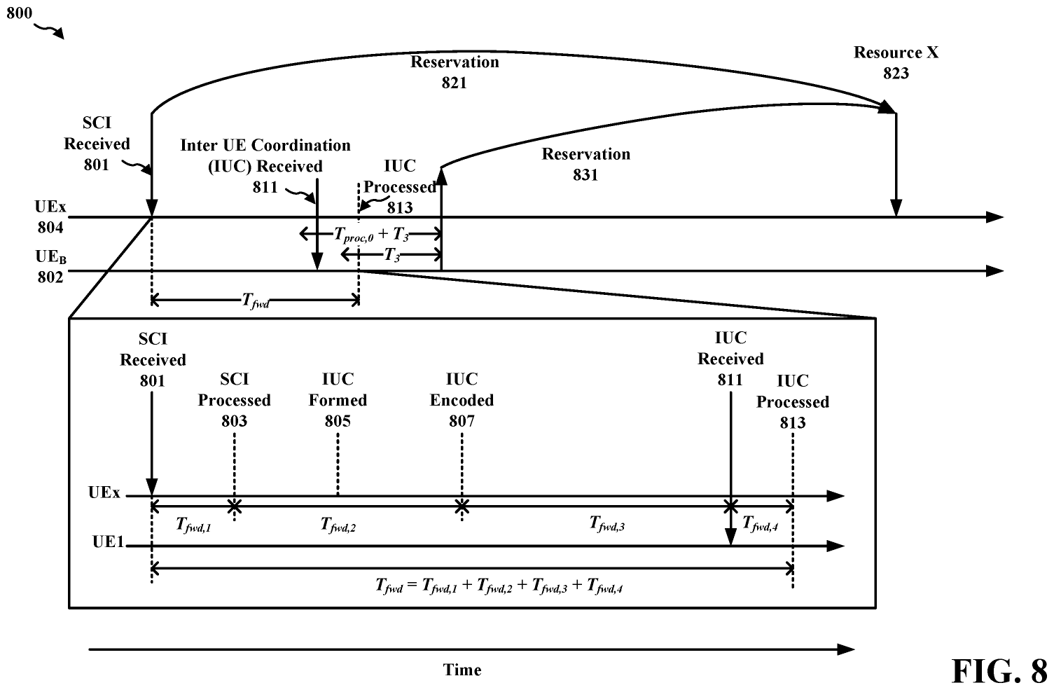

FIG. 8 is a diagram 800 illustrating a timeline for using inter UE coordination to inform a second UE, UE_{B} 802, of an SL resource reservation for a particular resource (e.g., resource X 823). Inter UE coordination may allow UEs that are (or will be) transmitting SL transmissions to different areas that overlap in a particular area (e.g., an area including UEₓ 804) to avoid conflicts in the particular overlapping area. A first SL resource reservation received (e.g., via SCI) at ‘SCI received’ 801 for a particular resource (e.g., resource X 823) and providing an inter UE coordination (IUC) message to other UEs (e.g., including UE_{B} 802) indicating the reserved resource (e.g., resource X 823).

The UEₓ 804 may process the received SCI during a time interval T_{fwd,1} between ‘SCI received’ 801 and ‘SCI processed’ 803. The processing performed by the UEₓ 804 may include decoding the SCI received at ‘SCI received’ 801 and determining the reserved resource (e.g., resource X 823). Based on the determination of the reserved resource (e.g., resource X 823), the UEₓ 804 may generate (e.g., between ‘SCI processed’ 803 and ‘IUC formed’ 805) an IUC message indicating the reserved resource to a set of other UEs (e.g., including the second UE_{B} 802). After generating (e.g., forming) the IUC message at ‘IUC formed’ 805, the IUC message may be encoded at ‘IUC encoded’ 807 and transmitted to the set of other UEs (e.g., including the second UE_{B} 802). The IUC generation and encoding may span a second time interval T_{fwd,2}. The IUC message may be included in a PSCCH symbol/resource, a PSSCH symbol/resource, or a feedback (e.g., PSFCH) symbol and may include less data than SCI including a reservation. The second UE_{B} 802 may receive the IUC message at ‘IUC reception’ 811 a time interval T_{fwd,3} after the IUC encoding at ‘IUC encoded’ 807. During a next time interval T_{fwd,4}, the second UE_{B} 802 may process the IUC message to identify the reserved resource and may complete the processing at ‘IUC processed’ 813.

As shown, the time ‘IUC received’ 811 may be after a sensing window ends (e.g., sensing window 602 of FIG. 6, or before reservation 831 by a time less than a time T_{proc,0}+T₃) such that the UE_{B} 802 may not consider the resource reservation indicated in the IUC message. Additionally, the time ‘IUC processed’ 813 may be after a resource is selected based on the sensing window (e.g., after a processing time for processing the transmissions received during the sensing window, or before the reservation 831 by a time less than a time T₃). In some aspects, the time T₃ may be a minimum time before an SL reservation transmission for a re-evaluation or a pre-emption procedure. Accordingly, diagram 800 illustrates that UE_{B} 802 may reserve, in reservation 831, the resource X 823 that was reserved in reservation 821 related to an SCI received at ‘SCI received’ 801. The time T_{fwd} between the time ‘SCI received’ 801 and the time ‘IUC processed’ 813 may depend, as discussed above, on any of intervals T_{fwd,1}, T_{fwd,2}, T_{fwd,3}, or T_{fwd,4} relating to the SCI processing, IUC generation, IUC encoding and transmission, and IUC processing respectively.

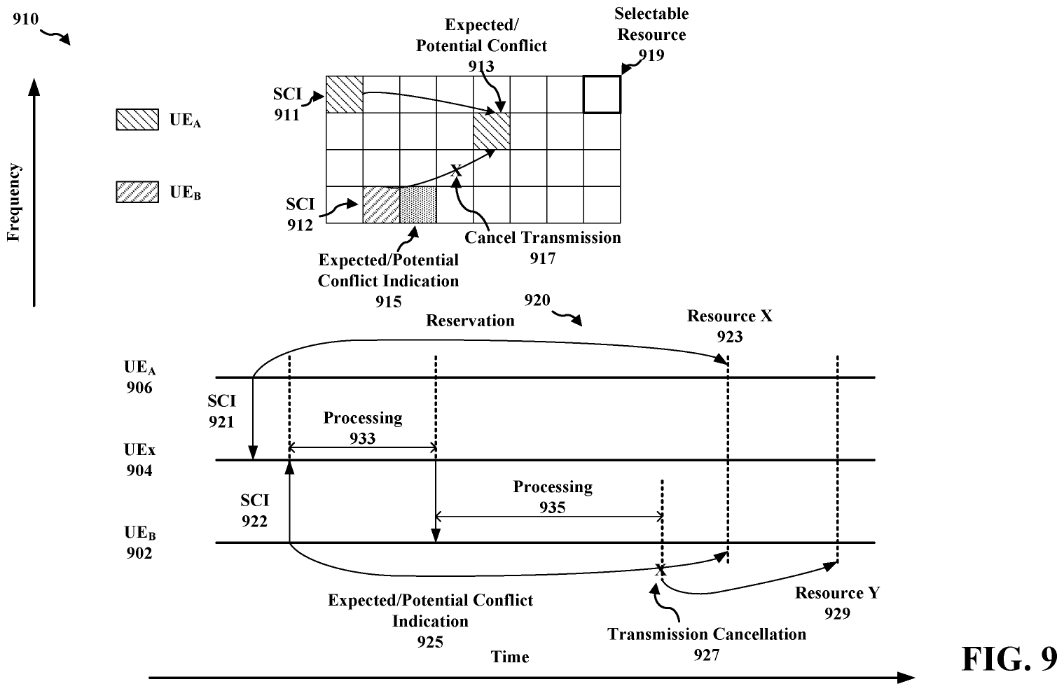

FIG. 9 is a set of diagrams 910 and 920 illustrating a timeline for transmitting an expected/potential conflict indication 915 or 925 based on a pair of reservations for a same SL resource received from two different UEs (e.g., UE_{A} 906 and UE_{B} 902). A UE, the UEₓ 904, may receive SCI 911 or 921 from UE_{A} 906 and SCI 912 or 922 from UE_{B} 902 that both include a reservation for a selectable resource (e.g., selectable resource 919 that may span one subcarrier in frequency and one slot in time) indicated as potential collision 913 (or a resource X 923). Based on identifying the potential collision 913 (e.g., via processing 933), the UEₓ 904 may generate and transmit an expected/potential conflict indication 915 or 925 to UE_{B} 902 (or in some aspects UE_{A} 906). The UE_{B} 902 (or in some aspects UE_{A} 906) may identify the collision (e.g., via processing 935), cancel the transmission via resource X 923 (indicated as transmission cancellation 917 or 927), and reserve and/or transmit on a new resource, resource Y 929. In some aspects, a benefit may be provided by reducing the processing time for the collision detection (e.g., by reducing a decoding time, reducing a time to identify potential collisions, reducing an encoding time, reducing a transmission time, etc.). In some aspects, a method of reducing the processing time is provided by reducing lag times (e.g., by reducing a minimum time gap) between identifying a potential collision/conflict and a resource (e.g., a symbol) allocated for transmitting an associated expected/potential conflict indication.

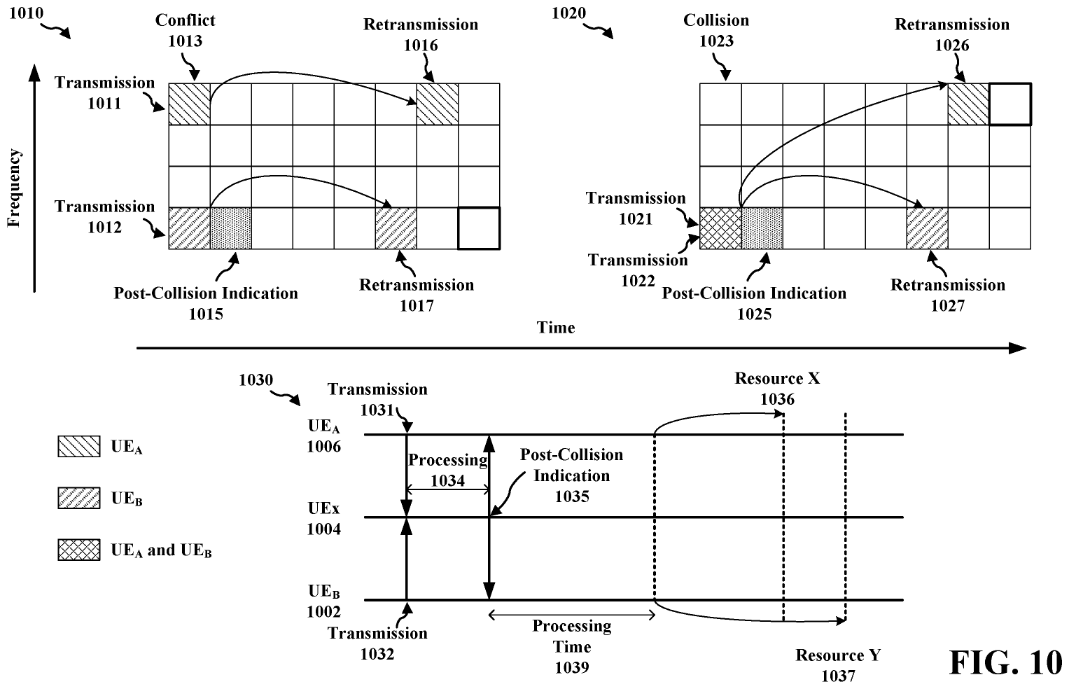

FIG. 10 is a set of diagrams 1010, 1020, and 1030 illustrating a timeline for transmitting a post-collision indication 1015, 1025, or 1035 based on a pair of conflicting or colliding SL transmission from two different UEs (e.g., UE_{A} 1006 and UE_{B} 1002). A UE, the UEₓ 1004, may receive conflicting or colliding SL transmissions 1011 and 1012, 1021 and 1022, or 1031 and 1032 during a first slot identified as conflict 1013 or collision 1023. Based on identifying the conflict 1013 or collision 1023 (e.g., via processing 1034), the UEₓ 1004 may generate and transmit a post-collision indication 1015, 1025, or 1035 to the UE_{A} 1006 and the UE_{B} 1002. The UE_{A} 1006 and the UE_{B} 1002 may process the post-collision indication 1015, 1025, or 1035 during processing time 1039 and may retransmit the SL transmission (e.g., SL transmission 1011, 1012, 1021, 1022, 1031, and 1032). The UE_{A} 1006 may retransmit via a resource 1016, 1026 or resource X 1036, while the UE_{B} 1002 may retransmit via a resource 1017, 1027 or resource Y 1037. In some aspects, a benefit may be provided by reducing the processing time for the collision detection (e.g., by reducing a decoding time, reducing a time to identify potential collisions, reducing an encoding time, reducing a transmission time, etc.). In some aspects, a method of reducing the processing time is provided by reducing lag times (e.g., by reducing a minimum time gap) between identifying a collision/conflict and a resource (e.g., a symbol) allocated for transmitting an associated post-collision indication.

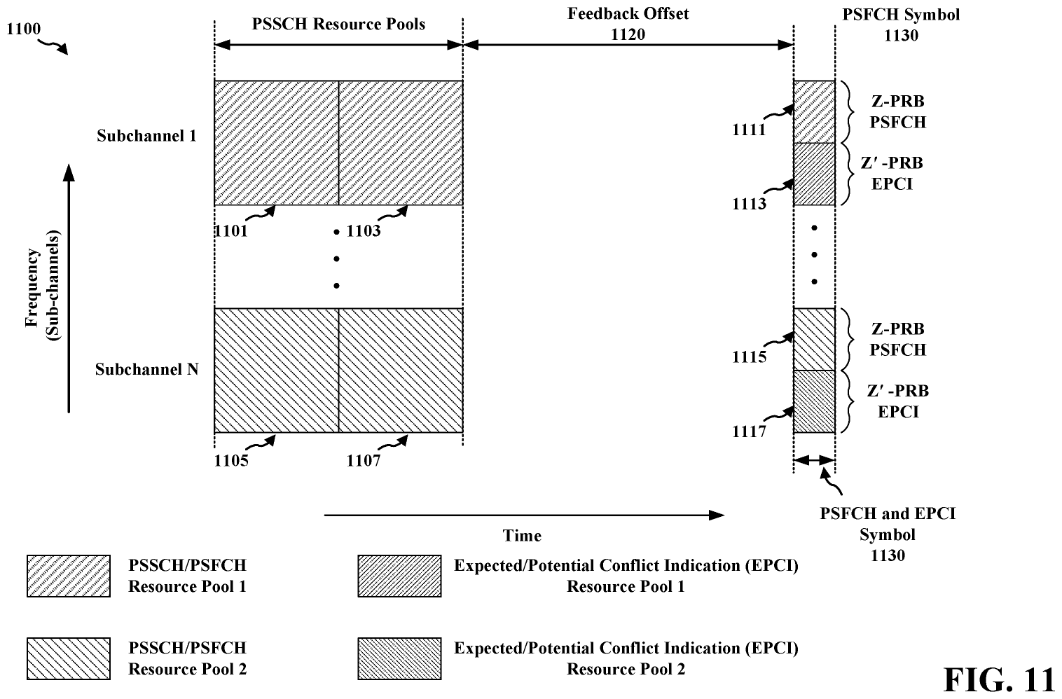

FIG. 11 is a diagram 1100 illustrating an example association between PSSCH resource pools 1101-1107, PSFCH resource sets 1111 and 1115 for transmitting and/or receiving HARQ feedback, and expected/potential conflict indication resource sets 1113 and 1117. Diagram 1100 illustrates a first set of PSSCH resource pools 1101 and 1103 and a second set of PSSCH resource pools 1105 and 1107 that are associated with a PSFCH resource sets 1111 and 1115, respectively, and expected/potential conflict indication resource sets 1113 and 1117, respectively. The PSFCH resource sets 1111 and/or 1115 may be within a same subchannel as the associated PSSCH resource pool 1101 or 1103 and/or 1105 or 1107 and may be separated in time by at least a feedback offset 1120. Similarly, the expected/potential conflict indication resource sets 1113 and/or 1117 may be within a same subchannel as the associated PSSCH resource pool 1101 or 1103 and/or 1105 or 1107 and may be separated in time by at least a feedback offset 1120. Each PSFCH resource set 1111 and 1115 in the PSFCH and EPCI symbol 1130 may include a set of “Z” PRBs within the subchannel, while each expected/potential conflict indication resource set 1111 and 1115 in the PSFCH symbol 1130 may include a set of “Z” PRBs within the subchannel. In some aspects, Z (and Z′) may be determined by dividing a number of PRBs within the subchannel between the PSFCH resource set 1111 and/or 1115 and the expected/potential conflict indication resource set 1113 and/or 1115. The number of PSSCH resource slots associated with a particular symbol of PSFCH may be determined by a PSFCH symbol frequency (or a periodicity of PSFCH symbols). For example, for a configuration with a PSFCH symbol every two slots, each PSFCH symbol in a particular subchannel may be associated with two PSSCH resource slots. Alternatively, for a configuration with a PSFCH symbol every four slots each PSFCH symbol in the particular subchannel may be associated with four PSSCH resource slots.

The number of independent PSFCH resources in a PSFCH resource set 1111 or 1115 and/or in the expected/potential conflict indication resource set 1113 and/or 1115 may be increased by enabling the use of “Y” different cyclic shifts (e.g., 1, 2, 3, 4, or 6 different cyclic shifts) for transmitting HARQ feedback and/or an expected/potential conflict indication in each frequency resource (e.g., set of PRBs, PRB, or set of subcarriers) in the PSFCH resource set and/or the expected/potential conflict indication resource set. The different cyclic shifts may enable a device receiving the HARQ feedback to identify HARQ feedback transmitted from multiple other devices (e.g., devices receiving a groupcast transmission) using a same frequency resource.

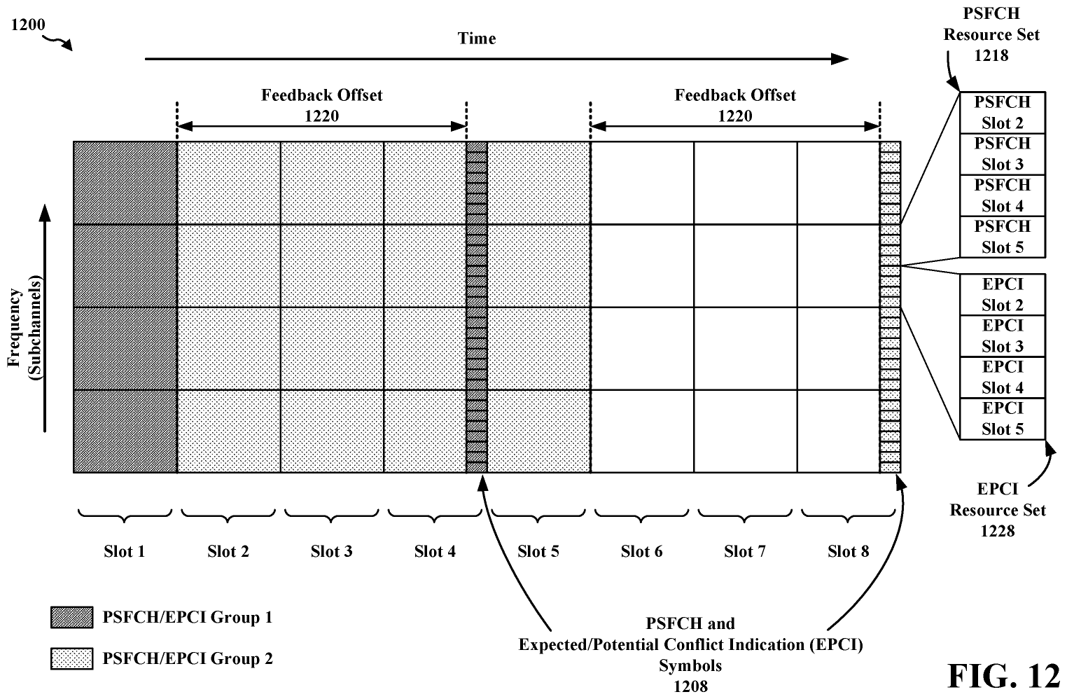

FIG. 12 is a diagram 1200 illustrating a set of subchannels associated with a PSFCH and expected/potential conflict indication symbols 1208. Each subchannel is associated with a first PSFCH resource set (e.g., PSFCH resource set 1218) and a second expected/potential conflict indication resource set (e.g., EPCI resource set 1228). Diagram 1200 illustrates that both PSFCH and EPCI share a minimum time gap (e.g., feedback offset 1220) of three slots and a periodicity of four slots, such that the slots 2-5 are associated with the PSFCH and expected/potential conflict indication symbol 1208 associated with slot 8. Diagram 1200 illustrates that the minimum delay between a PSSCH slot and a PSFCH symbol (e.g., in PSFCH resource set 1218) may be three slots and the maximum delay may be six slots in the case that the feedback offset if three slots and the periodicity of PSFCH resources is every four slots.

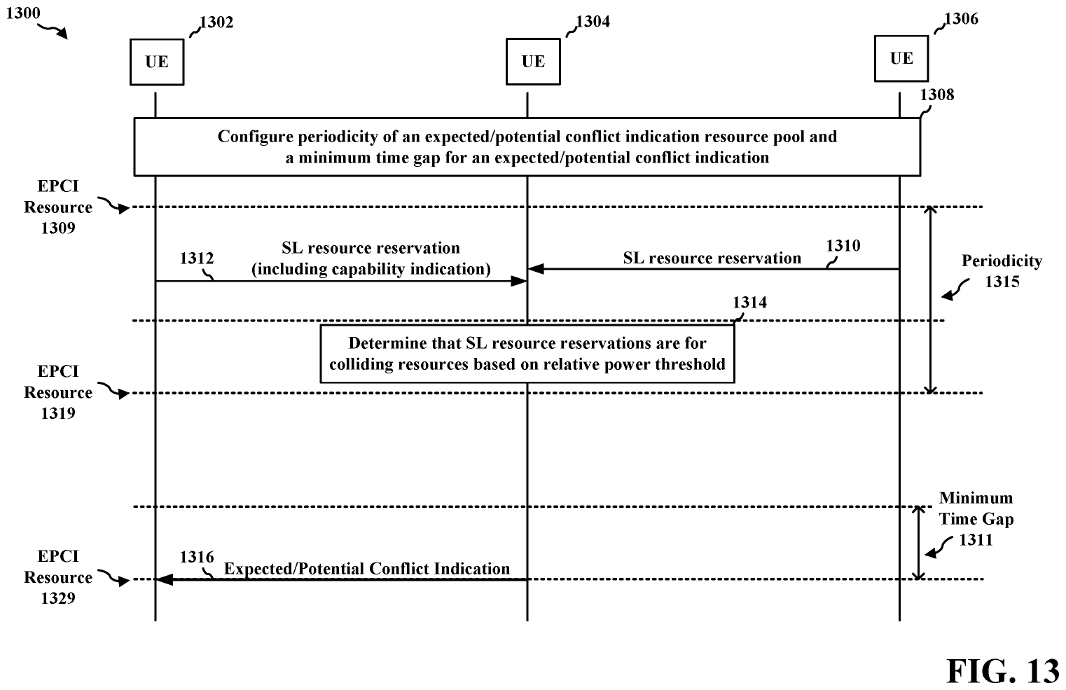

FIG. 13 is a call flow diagram 1300 illustrating a set of UEs being configured with a periodicity of collision (e.g., expected/potential conflict and/or post-collision) indication resource set and a minimum time gap between a reception of a first transmission and a transmission of an expected/potential conflict indication based on the received transmission. As an example, a set of UEs 1302-1306 may be configured 1308 with a periodicity of a collision (e.g., expected/potential conflict and/or post-collision) indication resource set (e.g., periodicity 1315 for EPCI resource sets 1309, 1319, 1329, and 1339) and a with a minimum time gap for an expected/potential conflict indication (e.g., minimum time gap 1311). In some aspects, the periodicity of the expected/potential conflict indication resource pool may be one of the same as, or different from, a periodicity of a PSFCH resource pool. For example, in some aspects, a UE may expect that a slot tₖ^{SL} (0≤ k<Tₘₐₓ) has a collision (e.g., expected/potential conflict and/or post-collision) indication transmission occasion resource if k mod N_{PSSCH}^{PSFCH}=0, where tₖ^{SL} is defined such that the set of slots that may belong to a sidelink resource pool is denoted by (t₀^{SL}, t₁^{SL}, . . . , T_{T}_{_{Max}}₋₁^{SL}) where 0≤tₖ^{SL}<10240 such that Tₘₐₓ is a number of slots that belong to the resource pool within 10240 msec and N_{PSSCH}^{PSFCH} is provided by sl-PSFCH-Period-r16.

In some aspects a UE may expect that a slot tₖ^{SL} has a (pre- or post-) collision indication transmission occasion resource if k mod N_{PSSCH}^{EPCI}=0, where tₖ^{SL} is defined as above and N_{PSSCH}^{EPCI} (or some other value indicating a EPCI resource pool periodicity in slots) is provided by a particular parameter, e.g., a parameter for specifying the periodicity of the expected/potential conflict indication resource slots (e.g., an sl-PCI-Period-r16 parameter). If a UE receives a PSSCH or PSCCH (e.g., including SCI) in a resource triggering an expected/potential conflict indication, the UE may provide the expected/potential conflict indication in an expected/potential conflict indication resource in the expected/potential conflict resource set when the trigger condition is met. The UE may transmit the collision indication in a first slot that includes expected/potential conflict indication resources of the resource set after a last slot of the PSSCH reception or after a slot during which the collision indication is triggered. Although an example is provided to illustrate the concept for an expected/potential conflict indication, the aspects may be similarly applied to a post-collision indication.

In some aspects, the minimum time gap for an expected/potential conflict indication (e.g., minimum time gap 1311), in some aspects, is one of the same as, or different from, a minimum time gap for a PSFCH. Increasing the frequency (e.g., decreasing the period) of the expected/potential conflict indication resource pools and/or decreasing a minimum time gap for an expected/potential conflict indication may make the expected/potential conflict indication more effective. For example, the T_{fwd} (e.g., between the time ‘SCI received’ 801 and the time ‘IUC processed’ 813) may be reduced as the expected/potential conflict indication may be provided more quickly and allow a UE reserving a conflicting/colliding resource to adjust the transmission of the SL transmission.

The UE 1306 may transmit, and the UE 1304 may receive, an SL resource reservation 1310 for a particular SL resource. The UE 1302 may subsequently transmit, and the UE 1304 may receive, a second SL resource reservation 1312 for the particular SL resource (or an SL resource during a same slot but at a different frequency subchannel/resource). The second SL resource reservation 1312 may include a capability indication indicating a capability to receive an expected/potential conflict indication. The capability indication may be transmitted and/or received via a capability bit included in SCI. In some aspects, the capability indication may be (implicitly) received at the UE 1304 based on a transmission or signal from the UE 1302 that indicates that the UE 1302 supports a particular set of capabilities including the capability to receive an expected/potential conflict indication. For example, if the second SL resource reservation 1312 (or some other transmission from UE 1302) includes a transmission specific to a particular release of the 3GPP standard or later that includes the capability to receive an expected/potential conflict indication, the UE 1304 may determine that the UE 1302 is capable of receiving an expected/potential conflict indication.

The UE 1304 may determine 1314 that the SL resource reservations 1310 and 1312 are for colliding SL resources (e.g., a same SL resource or SL resources during a same slot). As discussed below, the UE 1304 may determine 1314 that the SL resource reservations conflict/collide based on a relative power between the received first SL resource reservation 1310 and the received second SL resource reservation 1312 being within a particular relative power threshold range from multiple relative power threshold ranges for reservations of a same SL resource (or otherwise conflicting/colliding SL resources). As will be described below in relation to FIG. 16, in some aspects, the particular relative power threshold range from the multiple relative power threshold ranges for reservations of a same SL resource may be selected based on a number of criteria. For example, the particular relative power threshold range may be selected based on (1) a length of time between the received first SL resource reservation 1310 and the received second SL resource reservation 1312, (2) the modulation and coding scheme (MCS) associated with at least one of a first SCI (e.g., SCI-1), a second SCI (e.g., SCI-2), or data associated with the first or second SCI, (3) whether the collision is based on a reservation of a same SL resource or of SL resources during a same slot via different frequency subchannels, and/or (4) a distance between the UE 1304 and the UE 1302 from which the UE 1304 may receive the conflicting SL resource reservation and to which the UE 1304 may transmit the expected/potential conflict indication.

After the UE 1304 determines 1314 that the SL resource reservations conflict/collide, the UE 1304 may transmit an expected/potential conflict indication 1316. As illustrated for the expected/potential conflict indication 1316, the expected/potential conflict indication resource 1319, in some aspects, may not be used to transmit the expected/potential conflict indication 1316 despite the UE 1304 determining 1314 that the SL resource reservations conflict/collide before the expected/potential conflict indication resource 1319. In some aspects, the expected/potential conflict indication 1316 is not transmitted via the expected/potential conflict indication resource 1319 because the determination does not precede the expected/potential conflict indication resource 1319 by a minimum time gap 1311. Instead, the expected/potential conflict indication 1316, in some aspects, may be transmitted via an immediately subsequent expected/potential conflict indication resource 1329. In some aspects, an expected/potential conflict indication based on a determination that SL resource reservations conflict/collide that is made after a first expected/potential (e.g., expected/potential conflict indication resource 1319) conflict indication resource and before a next expected/potential conflict indication resource (e.g., expected/potential conflict indication resource 1329) is transmitted during the next expected/potential conflict indication resource. For example, if a determination that SL resource reservations conflict/collide precedes the next expected/potential conflict indication resource by the minimum time gap 1311, the expected/potential conflict indication may be transmitted via the next expected/potential conflict indication resource.

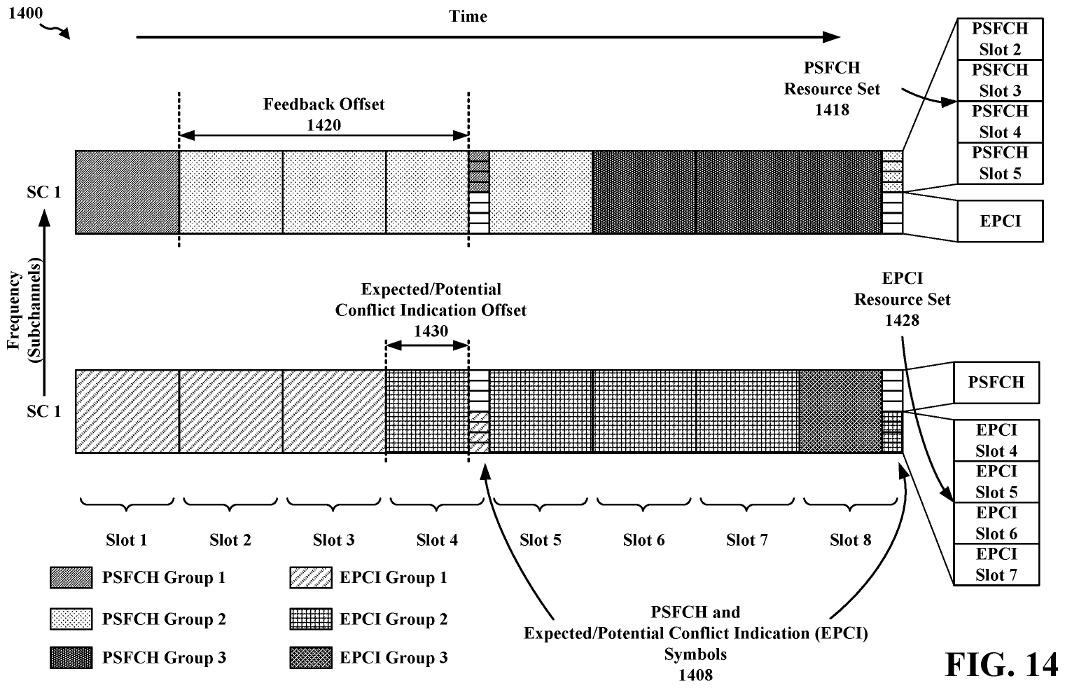

FIG. 14 is a diagram 1400 illustrating that PSFCH resource set 1418 and expected/potential conflict resource set 1428 in a combined set of PSFCH and expected/potential conflict indication resource set 1408 may be associated with different slots in the same sidelink resource pool. Diagram 1400 illustrates that a feedback offset 1420 for PSFCH may take a first value (e.g., three slots) while expected/potential conflict indication offset 1430 may take a second, different value (e.g., 1 slot or a number of symbols that make up less than a slot). Based on the different offset values for the PSFCH feedback (e.g., feedback offset 1420) and the offset values for expected/potential conflict indications (e.g., expected/potential conflict indication offset 1430) different slots may be associated with a same PSFCH/expected/potential conflict indication symbol for PSFCH feedback and for an expected/potential conflict indication. For example, PSFCH resource set 1418 (in slot 8) may be associated with slots 2-5, while collision indication resource set 1428 (in slot 8) may be associated with slots 4-7.

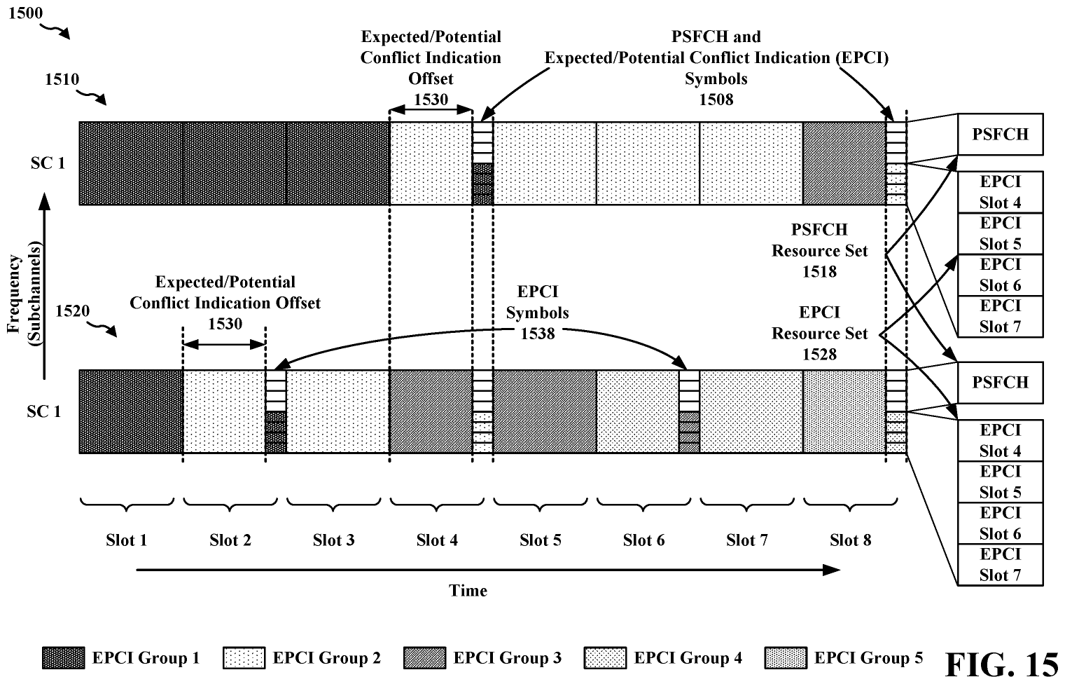

FIG. 15 is a diagram 1500 including diagrams 1510 and 1520 illustrating different configurations of PSFCH and expected/potential conflict indication symbols 1508, PSFCH resource set 1518, and expected/potential conflict indication resource set 1528. Diagram 1510 illustrates that a PSFCH resource set 1518 and an expected/potential conflict indication resource set 1528 (e.g., a combined PSFCH and expected/potential conflict indication resource symbol 1508) may have a same periodicity. Diagram 1520 illustrates that a PSFCH resource set 1518 may have a first periodicity (e.g., four slots) and expected/potential conflict indication resource sets 1528 and 1538 may have a second, different periodicity (e.g., two slots). The expected/potential conflict indication offset 1530 may be the same in diagrams 1510 and 1520 but the number and identities of the slots associated with each expected/potential conflict resource set 1528 and 1538 may be different.

FIG. 16 is a call flow diagram 1600 illustrating a UE 1604 receiving SL resource reservations (e.g., SL resource reservations 1608, 1610, 1616, and 1618), determining (e.g., 1612 and 1620) that the SL resource reservations conflict or collide, and transmitting expected/potential conflict indications 1614 and 1622. Diagram 1600 illustrates that the UE 1606 may transmit, and the UE 1604 may receive, a first SL resource reservation 1608 at a first time. The UE 1602 may transmit, and the UE 1604 may receive, a second SL resource reservation 1610 for a conflicting resource (e.g., a same SL resource or an SL resource at a same time but at a different, conflicting frequency). The second SL reservation 1610 may be received at a second time following the first time by a time difference 1609.

The UE 1604 may determine 1612 that the SL resource reservations 1608 and 1610 are for conflicting or colliding SL resources based on the time difference 1609. In some aspects, a collision may refer to SL resource reservations for a same time-and-frequency resource, while a conflict may refer to SL resource reservations for SL resources having different frequencies (e.g., subchannels) at a same time, e.g., within a same slot. In some aspects, a collision may be detected if the RSRPs of the colliding reservations are within a γₜₕ dB of each other, with γₜₕ representing a threshold RSRP difference. As an example, when the reservations are received within a threshold amount of time, the UE may send feedback if an RSRP of the received reservations are within γ_{th,close} of each other, with γ_{th,close}>γₜₕ. The UE 1604 may determine 1612 that the SL resource reservations collide based on a relative power between the received first SL resource reservation 1608 and the received second SL resource reservation 1610 being within a particular relative power threshold range of multiple relative power threshold ranges for reservations of a same SL resource (or for conflicting SL resources). The relative power threshold range may depend on one or more factors including a time difference between reception of the conflicting and/or colliding SL resource reservations, an MCS associated with each of the SL resource reservations, whether the resources overlap in both time and frequency or just in time, and a distance between the UEs.

In some aspects, the particular relative power threshold range may be based on the time difference 1609. Each relative power threshold range of the multiple relative power threshold ranges may be associated with a particular range of time differences between SL resource reservations for conflicting or colliding SL resources. For example, a first range of time differences including times longer than a time T_{fwd}+T_{proc,0}+T₃ (as defined above in relation to FIG. 8) may be associated with a first (group of) relative power threshold range(s), a second range of time differences including time differences between T_{fwd}+T_{proc,0}+T₃ and T_{proc,0}+T₃ may be associated with a second (group of) relative power threshold range(s), and a third range of time differences including time differences shorter than T_{proc,0}+T₃ may be associated with a third (group of) relative power threshold range(s). Although an example is provided for three power threshold ranges, the aspects presented herein may be applied to any number of two or more thresholds. The use of different thresholds based on the time difference between reservations may be applied for expected/potential conflict indications and/or for post-collision indications.

In some aspects, keeping all other factors besides the time difference on which the particular relative power threshold range constant, the first relative power threshold range may include a smaller range of relative powers (e.g., may be a less aggressive conflict identification), while the second relative power threshold range may include a larger range of relative powers than the first relative power threshold range, and the third relative power threshold range includes a larger range of relative powers than both the first relative power threshold range and second relative power threshold range. A relative power threshold range, in some aspects, may be based on a magnitude of the relative power between transmissions (e.g., transmitted SCI) associated with the first and second SL resource reservations. A range may be provided between [γ1, γ2], for example. As one, non-limiting example, a range may be between −3 dB and 3 dB) of the relative power between transmissions (e.g., transmitted SCI) associated with the first and second SL resource reservations. As an example, when the reservations are received within a threshold amount of time, the UE may send feedback if an RSRP of the received reservations are within a range [γ_{1,close}, γ_{2,close}], and γ_{1,close}<γ₁<γ₂<γ_{2,close}.

The factors affecting the relative power threshold range, in some aspects, may include the MCS associated with at least one of a first SCI (e.g., SCI-1), a second SCI (e.g., SCI-2), or data associated with the first or second SCI. For example, the relative power threshold range for SL reservations associated with an MCS with a higher signal to interference and noise ratio (SINR) threshold for decoding a transmission may be larger (may identify more collisions/conflict) than a relative power threshold range associated with an MCS with a lower SINR threshold for decoding a transmission. Additionally, if there is a mismatch between the MCS associated with a first SL resource reservation and a the MCS associated with a second SL resource reservation the relative power threshold range may be asymmetric about 0 (an upper bound of the range may have a greater magnitude than a lower bound of the range or vice versa)

In some aspects, the relative power threshold range may depend on whether the collision is based on a reservation of a same SL resource (e.g., a collision) or of SL resources during a same slot via different frequency subchannels (e.g., a half-duplex collision or a conflict based on leakage). For example, a relative power threshold, e.g., a relative power threshold value (as opposed to a relative power threshold range) of approximately ±24-30 dB between a first SL resource reservation for a first time-and-frequency resource and a second SL resource reservation for a second time-and-frequency resource overlapping in time, but not frequency, with the first resource, may have a greater magnitude than an upper bound, e.g., approximately 3 dB, or a lower bound, e.g., approximately −3 dB, of a relative power threshold range for colliding reservations. The different magnitude and the use of a threshold value (e.g., a range with either an upper or lower bound) for identifying the conflict may be based on concern for leakage between one frequency (e.g., subchannel) and another frequency (e.g., an adjacent subchannel) that occurs when a power associated with one transmission is so much greater than another that the leakage may cause interference.

The relative power threshold, in some aspects, may further be based on a distance between the UE 1602 transmitting the SL resource transmission 1610, the UE 1606 transmitting the SL resource reservation 1608, and/or the UE 1606 receiving the SL resource reservations 1608 and 1610. For example, if a distance is smaller than a threshold distance, ‘d’, the relative power threshold may be smaller than for a distance that is larger than the distance ‘d’. The distance ‘d’ may be estimated or determined based on zone information or location information when available.

After the UE 1604 determines 1612 that the SL resource reservations 1608 and 1610 collide and/or conflict, the UE 1604 may transmit, and UE 1602 may receive, expected/potential conflict indication 1614. The UE 1604 may transmit the expected/potential conflict indication to the UE 1602 based on a UE capability indication transmitted by the UE 1602 (e.g., included in SL resource reservation 1610 or previously transmitted SCI). If UE 1602 has not indicated that it is capable of receiving (e.g., processing or interpreting) an expected/potential conflict indication, but UE 1606 has indicated a capability of receiving an expected/potential conflict indication an expected/potential conflict indication may be transmitted to UE 1606 instead of UE 1602 as discussed in relation to skipped expected/potential conflict indication 1624. In some aspects, even if both UEs are capable of receiving an expected/potential conflict indication, the UE 1604 may transmit the expected/potential conflict indication to a previously reserving UE (e.g., the UE 1606 in call flow diagram 1600) based on a relative priority of the transmissions for which the SL resources have been reserved (e.g., the earlier-reserved resources being associated with a lower priority transmission than the later-reserved resources).

After transmitting expected/potential conflict indication 1614, the UE 1602 may transmit, and the UE 1604 may receive, a third SL resource reservation 1616. The UE 1606 may subsequently transmit, and the UE 1604 may receive, a fourth SL resource reservation 1618 for a conflicting or colliding SL resource at a time that is after receiving the third SL resource reservation 1616 by time difference 1617. The UE 1604 may determine 1620 that the SL resource reservations collide based on a relative power between the received third SL resource reservation 1616 and the received fourth SL resource reservation 1618 being within a particular relative power threshold range that may be different from the relative power threshold range used to determine 1612 that the first and second SL resource reservations collide. The different relative power threshold range may depend on the one or more factors discussed above.

After the UE 1604 determines 1620 that the SL resource reservations 1616 and 1618 collide and/or conflict, the UE 1604 may skip transmission of an expected/potential conflict indication 1624 to UE 1602 based on one or more factors (e.g., conditions) for not transmitting an expected/potential conflict indication. In some aspects, the distance between UEs, discussed above as a factor for a relative power threshold range, may be considered as a factor and/or a criteria for whether to skip an expected/potential conflict indication. For example, if a distance from the UE 1604 to at least one of the UE 1602 or the UE 1606 making the SL resource reservations is below a threshold distance, the UE 1604 may skip transmission of an expected/potential conflict indication.

In some aspects, skipping an expected/potential conflict indication may also be based on a received power of the SL resource reservation. For example, an SL resource reservation associated with a UE is received with a power (e.g., RSRP) that is within a range of powers indicating that a collision indication may interfere with sidelink feedback, a UE may skip transmission of an expected/potential conflict indication. The interference may be due to the UE receiving the expected/potential conflict indication with a power that is much greater than a feedback message transmitted in a same symbol by a more distant UE such that the leakage from the (pre- or post-) collision indication resources to the PSFCH resources interferes with the reception of the PSFCH resources. In some aspects, the expected/potential conflict indication may be skipped based on the SL resource reservations being for a SL communication having been transmitted at least a threshold number of times. For example, an N^{th} transmission of a SL communication (e.g., an (N−1)th retransmission), where N is greater than a threshold number ‘k’, may not trigger an expected/potential conflict indication. The threshold number ‘k’ may be based on the time difference between the reception of a first and second SL resource reservation as described above in relation to the relative power threshold where k is greater for SL resource reservations received closer in time than for SL resource reservations farther apart in time. For example, K_{close} may be used if the reservations are received with a time gap within the threshold amount of time, and k may be used if the reservations are received with a larger time gap, where k_{close}>k.

Although an example for expected/potential conflict indication is described in order to illustrate the concepts, aspects may be applied for post-collision indications, as well.

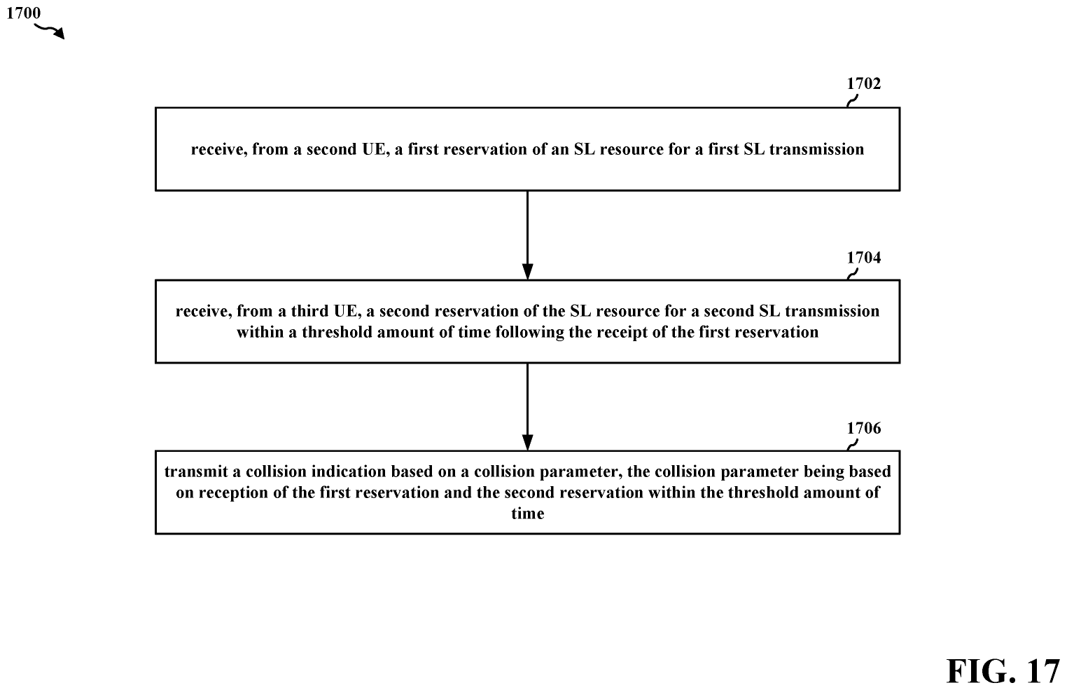

FIG. 17 is a flowchart 1700 of a method of wireless communication. The method may be performed by a first UE (e.g., the UE 104, 402-404, 706, 708, 904, 1304, and 1604; the apparatus 2102). At 1702, the first UE may receive, from a second UE, a first reservation of an SL resource for a first SL transmission. For example, referring to FIG. 16, the UE 1604 may receive SL resource reservation 1608 from the UE 1606. For example, 1702 may be performed by SL resource reservation component 2140.

At 1704, the first UE may receive, from a third UE, a second reservation of the SL resource for a second SL transmission within a threshold amount of time following the receipt of the first reservation. In some aspects, at least one of the second UE and the third UE may also transmit an indication of a capability relating to collision indication, such as a capability to receive an expected/potential conflict indication. The indication, in some aspects, is transmitted along with the SL resource reservation. For example, referring to FIG. 16, the UE 1604 may receive SL resource reservation 1610 from the UE 1602 and SL resource reservation 1610 may include an indication of a capability to receive an expected/potential conflict indication. For example, 1704 may be performed by SL resource reservation component 2140.

At 1706, the first UE may transmit a collision indication based on a collision parameter, the collision parameter being based on reception of the first reservation and the second reservation within the threshold amount of time. In some aspects, the UE may transmit an expected/potential conflict indication based on the collision parameter. In some aspects, the UE may transmit a post-collision indication based on the collision parameter. For example, 1706 may be performed by SL collision detection component 2142 and SL collision reporting component 2144. As discussed above, in relation to FIG. 16, in some aspects, the collision indication includes an expected/potential conflict indication based on a relative power between the received first reservation and the received second reservation being within a relative power threshold range of multiple relative power threshold ranges for reservations of a same SL resource. The collision indication, in some aspects, includes an expected/potential conflict indication based on a relative power between the received first reservation and the received second reservation being less than a relative power threshold based on the reception of the first reservation and the second reservation within the threshold amount of time, where the relative power threshold is one of a first relative power threshold associated with different reservations for a same time-and-frequency SL resource or a second relative power threshold associated with different reservations for different SL frequency resources that overlap in time. In some aspects, the relative power threshold range may be based on the reception of the first reservation and the second reservation within the threshold amount of time. The threshold amount of time may be within a range of times associated with the (applied) relative power threshold range.

Each relative power threshold range of the multiple relative power threshold ranges, in some aspects, may be associated with a distinct range of times between different reservations for a same SL resource. In some aspects, the (applied) relative power threshold range may be associated with a first range of times including the threshold amount of time and includes a larger range of relative powers than another relative power threshold range associated with a second range of times that are greater than the times included in the first range of times. As discussed above in relation to the relative power threshold range being based on an MCS, each relative power threshold range of the multiple relative power threshold ranges maybe determined based on at least one of an ability to decode data on the reserved SL resource, an ability to decode a first type of sidelink control information (SCI), or an ability to decode a second type of SCI.

In some aspects, the first UE may receive an indication of a collision indication reception capability of the second UE and the (pre-)collision indication may be transmitted to the second UE. The (pre-)collision indication may be transmitted to the second UE based on a priority associated with the second SL transmission. As discussed above, the indication of the collision indication reception capability of the second UE may be received via a reserved bit in SCI.

The first UE may transmit the expected/potential conflict indication in a first slot having expected/potential conflict resources of a resource pool and being at least a minimum time gap after a last slot in which a colliding reservation is received. The periodicity of the expected/potential conflict indication resource, in some aspects, may be a same periodicity as a feedback resource periodicity or may be different from a periodicity of a feedback resource periodicity. Additionally, in some aspects, a minimum time gap for an expected/potential conflict indication is less than a minimum time gap for feedback. Accordingly, in some aspects, the collision indication resource following the received reservation for the SL resource by at least the minimum time gap may precede an SL feedback resource following the reservation for the SL resource by at least the minimum time gap for feedback. In some aspects, the minimum time gap for an expected/potential conflict indication is less than one slot (e.g., 1-13 symbols of a 14-symbol slot).

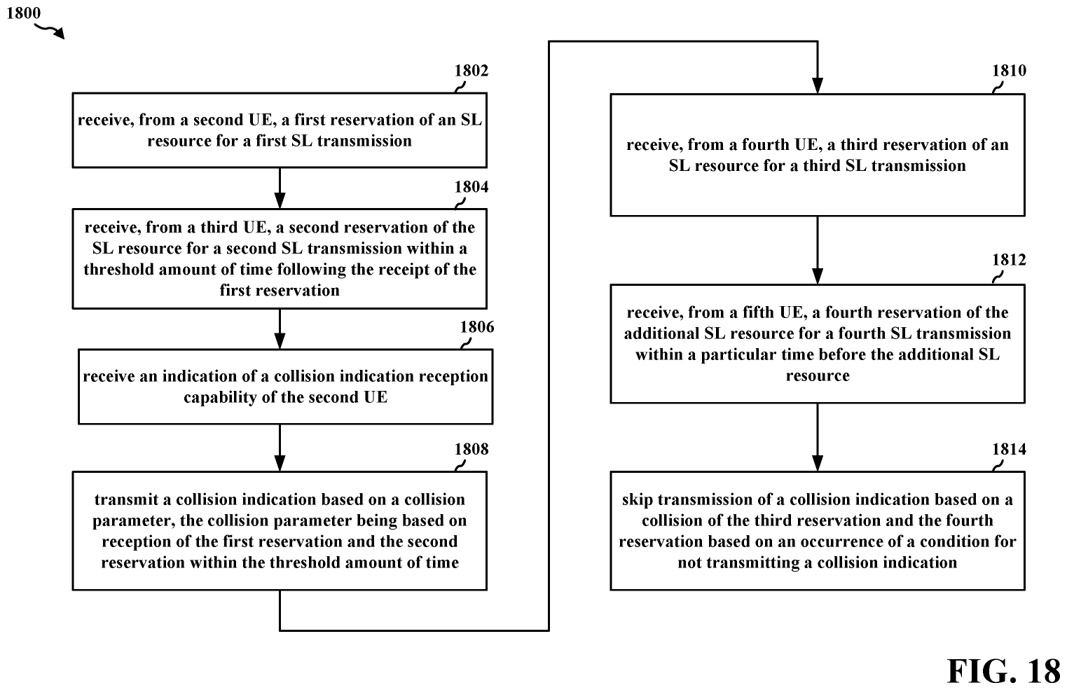

FIG. 18 is a flowchart 1800 of a method of wireless communication. The method may be performed by a first UE (e.g., the UE 104,402-404, 706, 708, 904, 1304, and 1604; the apparatus 2102). At 1802, the first UE may receive, from a second UE, a first reservation of an SL resource for a first SL transmission. For example, referring to FIG. 16, the UE 1604 may receive SL resource reservation 1608 from the UE 1606. For example, 1802 may be performed by SL resource reservation component 2140.

At 1804, the first UE may receive, from a third UE, a second reservation of the SL resource for a second SL transmission within a threshold amount of time following the receipt of the first reservation. For example, referring to FIG. 16, the UE 1604 may receive SL resource reservation 1610 from the UE 1602. For example, 1804 may be performed by SL resource reservation component 2140.

In some aspects, at least one of the second UE and the third UE may also transmit an indication of a capability to receive an expected/potential conflict indication. The indication, in some aspects, is transmitted along with the SL resource reservation. At 1806, the first UE may receive an indication of a collision indication reception capability of the second UE. The indication of the collision indication reception capability of the second UE may be received via a reserved bit in SCI. In some aspects, the capability indication may be (implicitly) received at the first UE based on a transmission or signal from the second or third UE that indicates that the second or third UE supports a particular set of capabilities including the capability to receive an expected/potential conflict indication. For example, referring to FIG. 16, the UE 1604 may receive SL resource reservation 1610 from the UE 1602 and SL resource reservation 1610 may include an indication of a capability to receive an expected/potential conflict indication. For example, 1806 may be performed by SL resource reservation component 2140.

At 1808, the first UE may transmit a collision indication based on a collision parameter, the collision parameter being based on reception of the first reservation and the second reservation within the threshold amount of time. For example, 1808 may be performed by SL collision detection component 2142 and SL collision reporting component 2144. As discussed above, in relation to FIG. 16, in some aspects, the collision indication includes an expected/potential conflict indication based on a relative power between the received first reservation and the received second reservation being within a relative power threshold range of multiple relative power threshold ranges for reservations of a same SL resource. The collision indication, in some aspects, includes an expected/potential conflict indication based on a relative power between the received first reservation and the received second reservation being less than a relative power threshold based on the reception of the first reservation and the second reservation within the threshold amount of time, where the relative power threshold is one of a first relative power threshold associated with different reservations for a same time-and-frequency SL resource or a second relative power threshold associated with different reservations for different SL frequency resources that overlap in time. In some aspects, the relative power threshold range may be based on the reception of the first reservation and the second reservation within the threshold amount of time. The threshold amount of time may be within a range of times associated with the (applied) relative power threshold range.

Each relative power threshold range of the multiple relative power threshold ranges, in some aspects, may be associated with a distinct range of times between different reservations for a same SL resource. In some aspects, the (applied) relative power threshold range may be associated with a first range of times including the threshold amount of time and includes a larger range of relative powers than another relative power threshold range associated with a second range of times that are greater than the times included in the first range of times. As discussed above in relation to the relative power threshold range being based on an MCS, each relative power threshold range of the multiple relative power threshold ranges maybe determined based on at least one of an ability to decode data on the reserved SL resource, an ability to decode a first type of sidelink control information (SCI), or an ability to decode a second type of SCI.

In some aspects, the first UE may receive an indication of a collision indication reception capability of the second UE and the (pre-)collision indication may be transmitted to the second UE. The (pre-)collision indication may be transmitted to the second UE based on a priority associated with the second SL transmission. As discussed above, the indication of the collision indication reception capability of the second UE may be received via a reserved bit in SCI.

The first UE may transmit the collision indication in a first slot having expected/potential conflict resources of a resource pool and being at least a minimum time gap after a last slot in which a colliding reservation is received. The periodicity of the expected/potential conflict indication resource, in some aspects, may be a same periodicity as a feedback resource periodicity or may be different from a periodicity of a feedback resource periodicity. Additionally, in some aspects, a minimum time gap for an expected/potential conflict indication is less than a minimum time gap for feedback. Accordingly, in some aspects, the collision indication resource following the received reservation for the SL resource by at least the minimum time gap may precede an SL feedback resource following the reservation for the SL resource by at least the minimum time gap for feedback. In some aspects, the minimum time gap for an expected/potential conflict indication is less than one slot (e.g., 1-13 symbols of a 14-symbol slot).

At 1810, the first UE may receive, from a fourth UE, a third reservation of an SL resource for a third SL transmission. For example, referring to FIG. 16, the UE 1604 may receive SL resource reservation 1616 from the UE 1602. For example, 1810 may be performed by SL resource reservation component 2140.

At 1812, the first UE may receive, from a fifth UE, a fourth reservation of the SL resource for a fourth SL transmission within a threshold amount of time following the receipt of the third reservation. For example, referring to FIG. 16, the UE 1604 may receive SL resource reservation 1618 from the UE 1606. For example, 1812 may be performed by SL resource reservation component 2140.

At 1814, the first UE may skip transmission of a collision indication based on a collision of the third reservation and the fourth reservation based on an occurrence of a condition for not transmitting a collision indication. As discussed above, the condition for not transmitting a collision indication may be at least one of (1) a distance to at least one of the third UE or the fourth UE being below a threshold distance, (2) a measured power of at least one of the third reservation and the fourth reservation being within a range of powers indicating that a collision indication may interfere with sidelink feedback, or (3) both the third reservation and the fourth reservation being for periodic transmissions having been transmitted at least a threshold number of times. In some aspects, the distance between the third UE or the fourth UE may be determined based on at least one of (1) zone information associated with the first UE and at least one of the third UE or the fourth UE or (2) location information associated with the first UE and at least one of the third UE or the fourth UE. For example, referring to FIG. 16, the UE 1604 may skip 1622 transmission of a collision indication (e.g., skipped expected/potential conflict indication 1624) based on an occurrence of a condition for not transmitting a collision indication. For example, 1814 may be performed by SL collision reporting component 2144.

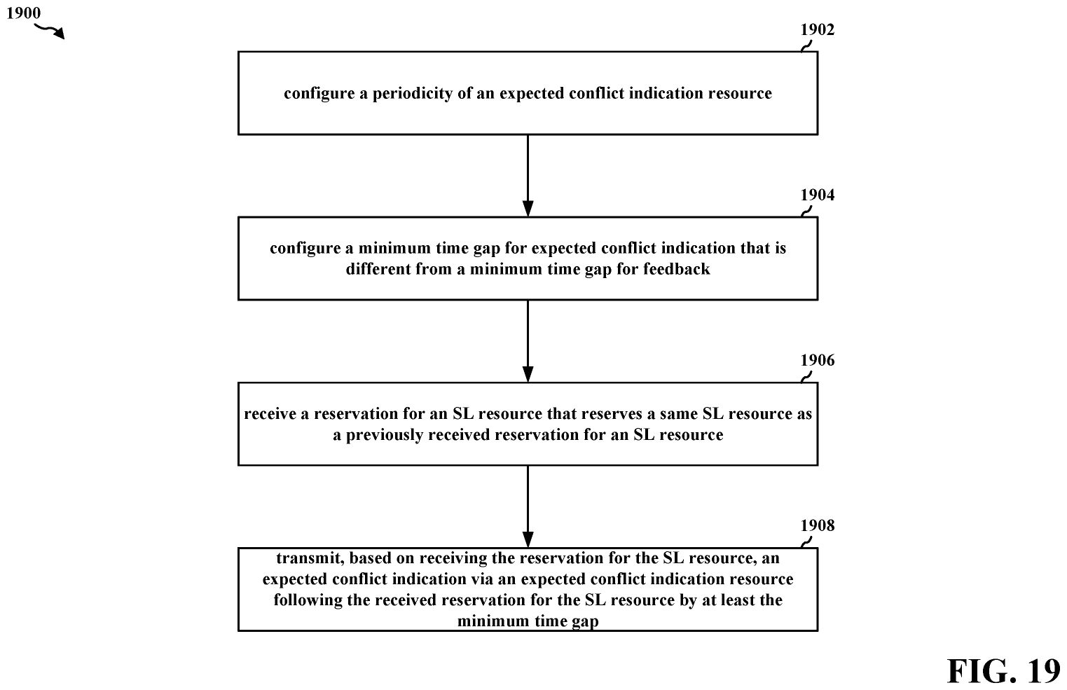

FIG. 19 is a flowchart 1900 of a method of wireless communication. The method may be performed by a first UE (e.g., the UE 104,402-404, 706, 708, 904, 1304, and 1604; the apparatus 2102). At 1902, the first UE may configure a periodicity of an expected/potential conflict indication resource. For example, referring to FIG. 13, the UE 1304 may be configured 1308 with a periodicity of an expected/potential conflict indication resource pool (e.g., periodicity 1315). For example, 1902 may be performed by SL collision reporting component 2144.

At 1904, the first UE may configure a minimum time gap for expected/potential conflict indication that is different from a minimum time gap for feedback. For example, referring to FIG. 13, the UE 1304 may be configured 1308 with a minimum time gap for an expected/potential conflict indication (e.g., minimum time gap 1311). For example, 1904 may be performed by SL collision reporting component 2144.

At 1906, the first UE may receive a reservation for an SL resource that reserves a same SL resource as a previously received reservation for an SL resource. In some aspects, at least one of the second UE and the third UE may also transmit an indication of a capability to receive an expected/potential conflict indication. The indication, in some aspects, is transmitted along with the SL resource reservation. For example, referring to FIG. 13, the UE 1302 may transmit, and the UE 1304 may receive, a second SL resource reservation 1312 for a particular SL resource. For example, 1906 may be performed by SL resource reservation component 2140.

At 1908, the first UE may transmit, based on receiving the reservation for the SL resource, an expected/potential conflict indication via an expected/potential conflict indication resource following the received reservation for the SL resource by at least the minimum time gap. In some aspects, the expected/potential conflict indication may be based on a collision parameter, the collision parameter being based on reception of the first reservation and the second reservation within the threshold amount of time. For example, 1908 may be performed by SL collision detection component 2142 and SL collision reporting component 2144. As discussed above, in relation to FIG. 16, in some aspects, the collision indication includes an expected/potential conflict indication based on a relative power between the received first reservation and the received second reservation being within a relative power threshold range of multiple relative power threshold ranges for reservations of a same SL resource. The collision indication, in some aspects, includes an expected/potential conflict indication based on a relative power between the received first reservation and the received second reservation being less than a relative power threshold based on the reception of the first reservation and the second reservation within the threshold amount of time, where the relative power threshold is one of a first relative power threshold associated with different reservations for a same time-and-frequency SL resource or a second relative power threshold associated with different reservations for different SL frequency resources that overlap in time. In some aspects, the relative power threshold range may be based on the reception of the first reservation and the second reservation within the threshold amount of time. The threshold amount of time may be within a range of times associated with the (applied) relative power threshold range.

Each relative power threshold range of the multiple relative power threshold ranges, in some aspects, may be associated with a distinct range of times between different reservations for a same SL resource. In some aspects, the (applied) relative power threshold range may be associated with a first range of times including the threshold amount of time and includes a larger range of relative powers than another relative power threshold range associated with a second range of times that are greater than the times included in the first range of times. As discussed above in relation to the relative power threshold range being based on an MCS, each relative power threshold range of the multiple relative power threshold ranges maybe determined based on at least one of an ability to decode data on the reserved SL resource, an ability to decode a first type of sidelink control information (SCI), or an ability to decode a second type of SCI.

In some aspects, the first UE may receive an indication of an expected/potential conflict indication reception capability of the second UE and the (pre-) collision indication may be transmitted to the second UE. The (pre-)collision indication may be transmitted to the second UE based on a priority associated with the second SL transmission. As discussed above, the indication of the collision indication reception capability of the second UE may be received via a reserved bit in SCI.

The first UE may transmit the expected/potential conflict indication in a first slot having expected/potential conflict resources of a resource pool and being at least a minimum time gap after a last slot in which a colliding reservation is received. The periodicity of the expected/potential conflict indication resource, in some aspects, may be a same periodicity as a feedback resource periodicity or may be different from a periodicity of a feedback resource periodicity. Additionally, in some aspects, a minimum time gap for an expected/potential conflict indication is less than a minimum time gap for feedback. Accordingly, in some aspects, the expected/potential conflict indication resource following the received reservation for the SL resource by at least the minimum time gap may precede an SL feedback resource following the reservation for the SL resource by at least the minimum time gap for feedback. In some aspects, the minimum time gap for an expected/potential conflict indication is less than one slot (e.g., 1-13 symbols of a 14-symbol slot).

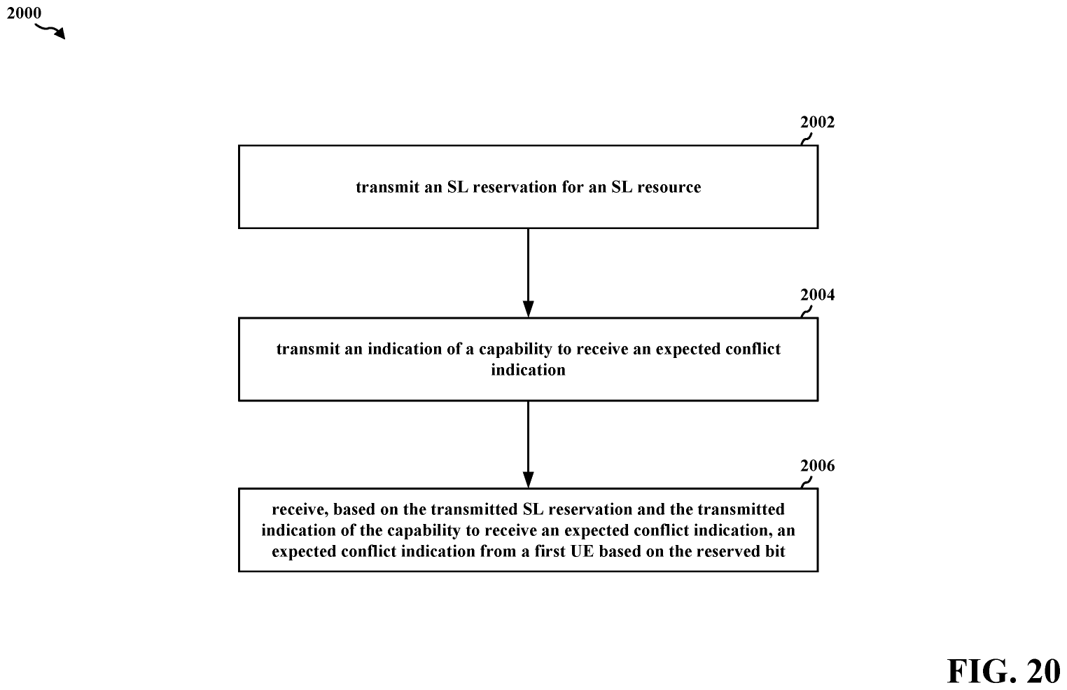

FIG. 20 is a flowchart 2000 of a method of wireless communication. The method may be performed by a second UE (e.g., the UE 104,402-404, 706, 708, 902, 1302, and 1602; the apparatus 2102). At 2002, the second UE may transmit an SL reservation for an SL resource. For example, referring to FIGS. 13 and 16, the UE 1302 and 1602 may transmit SL resource reservation 1312 and 1610, respectively. For example, 2002 may be performed by SL resource reservation component 2140.

At 2004, the second UE may transmit an indication of a capability to receive an expected/potential conflict indication. For example, referring to FIGS. 13 and 16, the UE 1302 and 1602 may transmit SL resource reservation 1312 including a capability indication and 1610 including a capability indication, respectively. For example, 2004 may be performed by SL resource reservation component 2140.

At 2006, the second UE may receive, based on the transmitted SL reservation and the indication of the capability to receive an expected/potential conflict indication, an expected/potential conflict indication from a first UE. For example, referring to FIGS. 13 and 16, the UE 1302 and 1602 may receive expected/potential conflict indication 1316 and 1616, respectively. For example, 2006 may be performed by SL resource reservation component 2140.

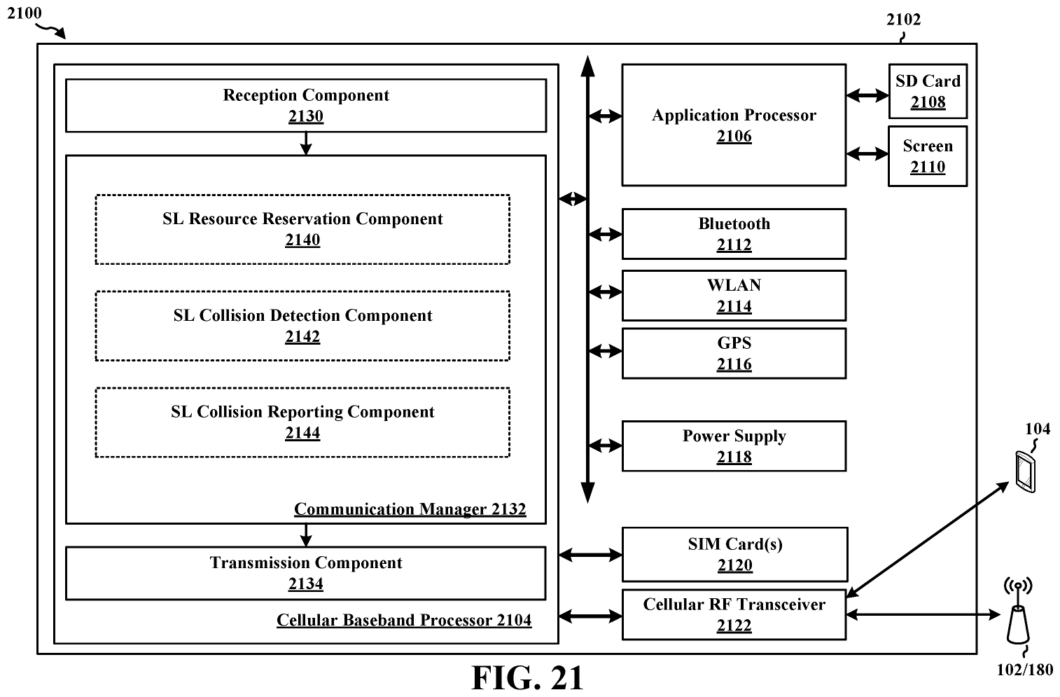

FIG. 21 is a diagram 2100 illustrating an example of a hardware implementation for an apparatus 2102. The apparatus 2102 may be a UE, or another device configured to transmit and/or receive sidelink communication. The apparatus 2102 includes a baseband processor 2104 (also referred to as a modem) coupled to a RF transceiver 2122. In some aspects, the baseband processor 2104 may be a cellular baseband processor and/or the RF transceiver 2122 may be a cellular RF transceiver. The apparatus 2102 may further include one or more subscriber identity modules (SIM) cards 2120, an application processor 2106 coupled to a secure digital (SD) card 2108 and a screen 2110, a Bluetooth module 2112, a wireless local area network (WLAN) module 2114, a Global Positioning System (GPS) module 2116, and/or a power supply 2118. The baseband processor 2104 communicates through the RF transceiver 2122 with the UE 104 and/or BS 102/180. The baseband processor 2104 may include a computer-readable medium/memory. The computer-readable medium/memory may be non-transitory. The baseband processor 2104 is responsible for general processing, including the execution of software stored on the computer-readable medium/memory. The software, when executed by the baseband processor 2104, causes the baseband processor 2104 to perform the various functions described in the present application. The computer-readable medium/memory may also be used for storing data that is manipulated by the baseband processor 2104 when executing software. The baseband processor 2104 further includes a reception component 2130, a communication manager 2132, and a transmission component 2134. The communication manager 2132 includes the one or more illustrated components. The components within the communication manager 2132 may be stored in the computer-readable medium/memory and/or configured as hardware within the baseband processor 2104. The baseband processor 2104 may be a component of the device 350 and may include the memory 360 and/or at least one of the TX processor 368, the RX processor 356, and the controller/processor 359. In one configuration, the apparatus 2102 may be a modem chip and include just the baseband processor 2104, and in another configuration, the apparatus 2102 may be the entire UE (e.g., see 350 of FIG. 3) and include the additional modules of the apparatus 2102.

The communication manager 2132 includes an SL resource reservation component 2140 that is configured to receive and transmit SL resource reservations and to transmit and receive an indication of a capability to receive an expected/potential conflict indication, e.g., as described in connection with 1702, 1704, 1802, 1804, 1806, 1810, 1812, 1906, 2002, 2004, and 2006 of FIGS. 17-20. The communication manager 2132 further includes an SL collision detection component 2142 that receives input in the form of SL resource reservations from the component 2140 and is configured to detect a collision or conflict between different reservations for a same, or overlapping in time, SL resource(s), e.g., as described in connection with 1706, 1808, 1814, and 1908 of FIGS. 17-19. The communication manager 2132 further includes an SL collision reporting component 2144 that receives input in the form of a detected collision or conflict from the SL collision detection component 2142 and is configured to transmit a collision indication based on a collision parameter and to skip transmission of a collision indication based on an occurrence of a condition for not transmitting a collision indication, e.g., as described in connection with 1706, 1808, 1814, and 1908 of FIGS. 17-19.

The apparatus may include additional components that perform each of the blocks of the algorithm in the flowcharts of FIGS. 17-20. As such, each block in the flowcharts of FIGS. 17-20 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 2102, and in particular the baseband processor 2104, includes means for receiving, from a second UE, a first reservation of an SL resource for a first SL transmission. The apparatus 2102, and in particular the baseband processor 2104, may further include means for receiving, from a third UE, a second reservation of the SL resource for a second SL transmission within a threshold amount of time following the receipt of the first reservation. The apparatus 2102, and in particular the baseband processor 2104, may further include means for transmitting a collision indication based on a collision parameter, where the collision parameter is based on receiving the second reservation within the threshold amount of time following the reception of the first reservation. The apparatus 2102, and in particular the baseband processor 2104, may further include means for receiving an indication of a collision indication reception capability of the second UE. The apparatus 2102, and in particular the baseband processor 2104, may further include means for receiving, from a fourth UE, a third reservation of an additional SL resource for a third SL transmission. The apparatus 2102, and in particular the baseband processor 2104, may further include means for receiving, from a fifth UE, a fourth reservation of the additional SL resource for a fourth SL transmission within a particular time before the additional SL resource. The apparatus 2102, and in particular the baseband processor 2104, may further include means for skipping transmission of a collision indication based on a collision of the third reservation and the fourth reservation based on an occurrence of a condition for not transmitting a collision indication. The apparatus 2102, and in particular the baseband processor 2104, may further include means for transmitting an SL reservation for an SL resource. The apparatus 2102, and in particular the baseband processor 2104, may further include means for transmitting an indication of a capability to receive an expected conflict indication. The apparatus 2102, and in particular the baseband processor 2104, may further include means for receiving, based on the transmitted SL reservation and the indication of the capability to receive an expected/potential conflict indication, an expected conflict indication from a first UE. The apparatus 2102, and in particular the baseband processor 2104, may further include means for configuring a periodicity of an expected conflict indication resource. The apparatus 2102, and in particular the baseband processor 2104, may further include means for configuring a minimum time gap for expected conflict indication that is different from a minimum time gap for feedback. The apparatus 2102, and in particular the baseband processor 2104, may further include means for receiving a reservation for an SL resource that reserves a same SL resource as a previously received reservation for an SL resource. The apparatus 2102, and in particular the baseband processor 2104, may further include means for transmitting, based on receiving the reservation for the SL resource, an expected conflict indication via an expected conflict indication resource following the received reservation for the SL resource by at least the minimum time gap. The means may be one or more of the components of the apparatus 2102 configured to perform the functions recited by the means. As described herein, the apparatus 2102 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Aspect 1 is an apparatus for wireless communication including at least one processor coupled to a memory and configured to receive, from a second UE, a first reservation of a SL resource for a first SL transmission; receive, from a third UE, a second reservation of the SL resource for a second SL transmission within a threshold amount of time following the reception of the first reservation; and transmit a collision indication based on a collision parameter, where the collision parameter is based on receiving the second reservation within the threshold amount of time following the reception of the first reservation.

Aspect 2 is the apparatus of aspect 1, where the collision parameter includes a relative power threshold range from a plurality of relative power threshold ranges for reservations of a same SL resource, the relative power threshold range is associated with the reception of the first reservation and the reception of the second reservation being within the threshold amount of time, and the collision indication includes an expected conflict indication based on a relative power between the received first reservation and the received second reservation being within the relative power threshold range.

Aspect 3 is the apparatus of aspect 2, where the threshold amount of time is within a range of times associated with the relative power threshold range.

Aspect 4 is the apparatus of any of aspects 2 or 3, where each relative power threshold range in the plurality of relative power threshold ranges is associated with a distinct range of times between different reservations for a same SL resource.

Aspect 5 is the apparatus of aspect 4, where the relative power threshold range is associated with a first range of times including the threshold amount of time and includes a larger range of relative powers than another relative power threshold range associated with a second range of times that are greater than the times included in the first range of times.

Aspect 6 is the apparatus of any of aspects 2 to 5, where each relative power threshold range in the plurality of relative power threshold ranges is determined based on at least one of an ability to decode data on the reserved SL resource, an ability to decode a first type of SCI, or an ability to decode a second type of SCI.

Aspect 7 is the apparatus of aspect 1, where the collision parameter includes a relative power threshold associated with the reception of the first reservation and the reception of the second reservation being within the threshold amount of time, and the collision indication includes an expected conflict indication based on a relative power between the received first reservation and the received second reservation being less than relative power threshold.

Aspect 8 is the apparatus of aspect 7, where the relative power threshold is one of a first relative power threshold associated with different reservations for a same time-and-frequency SL resource or a second relative power threshold associated with different reservations for different SL frequency resources that overlap in time.

Aspect 9 is the apparatus of any of aspects 1 to 8, where transmitting the collision indication includes transmitting the collision indication to the second UE.

Aspect 10 is the apparatus of aspect 9, where the collision indication is transmitted to the second UE based on a priority associated with the second SL transmission.

Aspect 11 is the apparatus of any of aspects 9 or 10, the at least one processor further configured to receive an indication of a collision indication reception capability of the second UE.

Aspect 12 is the apparatus of aspect 11, where the indication of the collision indication reception capability of the second UE is received via a reserved bit in SCI.

Aspect 13 is the apparatus of any of aspects 1 to 12, the at least one processor further configured to receive, from a fourth UE, a third reservation of an additional SL resource for a third SL transmission; receive, from a fifth UE, a fourth reservation of the additional SL resource for a fourth SL transmission within a particular time before the additional SL resource; and skip transmission of a collision indication based on a collision of the third reservation and the fourth reservation based on an occurrence of a condition for not transmitting a collision indication.

Aspect 14 is the apparatus of aspect 13, where the condition for not transmitting a collision indication is at least one of (1) a distance to at least one of the third UE or the fourth UE being below a threshold distance, (2) a measured power of at least one of the third reservation and the fourth reservation being within a range of powers indicating that a collision indication may interfere with sidelink feedback, or (3) both the third reservation and the fourth reservation being for a transmission having been transmitted at least a threshold number of times.

Aspect 15 is the apparatus of aspect 14, where the distance between the third UE or the fourth UE is based on at least one of (1) zone information associated with the first UE and at least one of the third UE or the fourth UE or (2) location information associated with the first UE and at least one of the third UE or the fourth UE.

Aspect 16 is the apparatus of any of aspects 1 to 15, where the collision indication is an expected conflict indication, and the apparatus transmits the expected conflict indication in a first slot having expected conflict indication resources of a resource pool and being at least a minimum time gap after a last slot in which a colliding reservation is received.

Aspect 17 is the apparatus of aspect 16, where a periodicity of the expected conflict indication resource is a same periodicity as a feedback resource periodicity.

Aspect 18 is the apparatus of aspect 16, where a periodicity of the expected conflict indication resource is different from a periodicity of a feedback resource periodicity.

Aspect 19 is the apparatus of any of aspects 16 to 18, where a minimum time gap for an expected conflict indication is less than a minimum time gap for feedback.

Aspect 20 is the apparatus of aspect 19, where the expected conflict indication resource following the received reservation for the SL resource by at least the minimum time gap precedes a SL feedback resource following the reservation for the SL resource by at least the minimum time gap for feedback.

Aspect 21 is the apparatus of any of aspects 16 to 20, where the minimum time gap for an expected conflict indication is less than one slot.

Aspect 22 is the apparatus of any of aspects 1 to 21, further including at least one transceiver coupled to the at least one processor.

Aspect 23 is an apparatus for wireless communication including at least one processor coupled to a memory and configured to transmit a SL reservation for a SL resource, transmit an indication of a capability to receive an expected conflict indication, and receive, based on the transmitted SL reservation and the indication of the capability to receive an expected conflict indication, an expected conflict indication from a first UE.

Aspect 24 is the apparatus of aspect 23, where the indication indicating the capability to receive an expected conflict indication includes at least one bit in a SCI message.

Aspect 25 is the apparatus of aspect 24, where the at least one bit indicating the capability to receive an expected conflict indication includes a reserved bit in the SCI message.

Aspect 26 is the apparatus of any of aspects 24 or 25, where the SL reservation is comprised in the SCI message.

Aspect 27 is the apparatus of any of aspects 23 to 26, further including at least one transceiver coupled to the at least one processor.

Aspect 28 is a method of wireless communication for implementing any of aspects 1 to 27.

Aspect 29 is an apparatus for wireless communication including means for implementing any of aspects 1 to 27.

Aspect 30 is a computer-readable medium storing computer executable code, where the code when executed by a processor causes the processor to implement any of aspects 1 to 27.

1. An apparatus for wireless communication comprising:
a memory; and
at least one processor coupled to the memory and configured to:
receive, from a second user equipment (UE), a first reservation of a sidelink (SL) resource for a first SL transmission;
receive, from a third UE, a second reservation of the SL resource for a second SL transmission within a threshold amount of time following the reception of the first reservation; and
transmit a collision indication based on a collision parameter, wherein the collision parameter is based on receiving the second reservation within the threshold amount of time following the reception of the first reservation.

2. The apparatus of claim 1, wherein
the collision parameter includes a relative power threshold range from a plurality of relative power threshold ranges for reservations of a same SL resource,
the relative power threshold range is associated with the reception of the first reservation and the reception of the second reservation being within the threshold amount of time, and
the collision indication includes an expected conflict indication based on a relative power between the received first reservation and the received second reservation being within the relative power threshold range.

3. The apparatus of claim 2, wherein the threshold amount of time is within a range of times associated with the relative power threshold range.

4. The apparatus of claim 2, wherein each relative power threshold range in the plurality of relative power threshold ranges is associated with a distinct range of times between different reservations for a same SL resource.

5. The apparatus of claim 4, wherein the relative power threshold range is associated with a first range of times including the threshold amount of time and comprises a larger range of relative powers than another relative power threshold range associated with a second range of times that are greater than the times included in the first range of times.

6. The apparatus of claim 2 wherein each relative power threshold range in the plurality of relative power threshold ranges is determined based on at least one of an ability to decode data on the reserved SL resource, an ability to decode a first type of sidelink control information (SCI), or an ability to decode a second type of SCI.

7. The apparatus of claim 1, wherein
the collision parameter comprises a relative power threshold associated with the reception of the first reservation and the reception of the second reservation being within the threshold amount of time, and
the collision indication comprises an expected conflict indication based on a relative power between the received first reservation and the received second reservation being less than relative power threshold.

8. The apparatus of claim 7, wherein the relative power threshold is one of a first relative power threshold associated with different reservations for a same time-and-frequency SL resource or a second relative power threshold associated with different reservations for different SL frequency resources that overlap in time.

9. The apparatus of claim 1, wherein transmitting the collision indication comprises transmitting the collision indication to the second UE.

10. The apparatus of claim 9, wherein the collision indication is transmitted to the second UE based on a priority associated with the second SL transmission.

11. The apparatus of claim 9, the at least one processor further configured to:
receive an indication of a collision indication reception capability of the second UE.

12. The apparatus of claim 11, wherein the indication of the collision indication reception capability of the second UE is received via a reserved bit in sidelink control information.

13. The apparatus of claim 1, the at least one processor further configured to:
receive, from a fourth UE, a third reservation of an additional SL resource for a third SL transmission;
receive, from a fifth UE, a fourth reservation of the additional SL resource for a fourth SL transmission within a particular time before the additional SL resource; and
skip transmission of a collision indication based on a collision of the third reservation and the fourth reservation based on an occurrence of a condition for not transmitting a collision indication.

14. The apparatus of claim 13, wherein the condition for not transmitting a collision indication is at least one of (1) a distance to at least one of the third UE or the fourth UE being below a threshold distance, (2) a measured power of at least one of the third reservation and the fourth reservation being within a range of powers indicating that a collision indication may interfere with sidelink feedback, or (3) both the third reservation and the fourth reservation being for a SL communication having been transmitted at least a threshold number of times.

15. The apparatus of claim 14, wherein the distance between the third UE or the fourth UE is based on at least one of (1) zone information associated with the first UE and at least one of the third UE or the fourth UE or (2) location information associated with the first UE and at least one of the third UE or the fourth UE.

16. The apparatus of claim 1, wherein the collision indication is an expected conflict indication, and the apparatus transmits the expected conflict indication in a first slot having expected conflict indication resources of a resource pool and being at least a minimum time gap after a last slot in which a colliding reservation is received.

17. The apparatus of claim 16, wherein a periodicity of the expected conflict indication resource is a same periodicity as a feedback resource periodicity.

18. The apparatus of claim 16, wherein a periodicity of the expected conflict indication resource is different from a periodicity of a feedback resource periodicity.

19. The apparatus of claim 16, wherein a minimum time gap for an expected conflict indication is less than a minimum time gap for feedback.

20. The apparatus of claim 19, wherein the expected conflict indication resource following the received reservation for the SL resource by at least the minimum time gap precedes a SL feedback resource following the reservation for the SL resource by at least the minimum time gap for feedback.

21. The apparatus of claim 16, wherein the minimum time gap for an expected conflict indication is less than one slot.

22. The apparatus of claim 1, further comprising at least one transceiver coupled to the at least one processor.

23. An apparatus for wireless communication comprising:
a memory; and
at least one processor coupled to the memory and configured to:
transmit a sidelink (SL) reservation for a SL resource;
transmit an indication of a capability to receive an expected conflict indication; and
receive, based on the transmitted SL reservation and the indication of the capability to receive an expected conflict indication, an expected conflict indication from a first user equipment (UE).

24. The apparatus of claim 23, wherein the indication indicating the capability to receive an expected conflict indication comprises at least one bit in a sidelink control information (SCI) message.

25. The apparatus of claim 24, wherein the at least one bit indicating the capability to receive an expected conflict indication comprises a reserved bit in the SCI message.

26. The apparatus of claim 24, wherein the SL reservation is comprised in the SCI message.

27. The apparatus of claim 23, further comprising at least one transceiver coupled to the at least one processor.

28. A method of wireless communication for a first user equipment (UE), comprising:
receiving, from a second UE, a first reservation of a sidelink (SL) resource for a first SL transmission;
receiving, from a third UE, a second reservation of the SL resource for a second SL transmission within a threshold amount of time following the reception of the first reservation; and
transmitting a collision indication based on a collision parameter, wherein the collision parameter is based on receiving the second reservation within the threshold amount of time following the reception of the first reservation.

29. The method of claim 28, wherein
the collision parameter comprises a relative power threshold range from a plurality of relative power threshold ranges for reservations of a same SL resource,
the relative power threshold range is associated with the reception of the first reservation and the reception of the second reservation being within the threshold amount of time, and
the collision indication comprises an expected conflict indication based on a relative power between the received first reservation and the received second reservation being within the relative power threshold range.

30. A method of wireless communication for a second user equipment (UE), comprising:
transmitting a sidelink (SL) reservation for a SL resource;
transmitting an indication of a capability to receive an expected conflict indication; and
receiving, based on the transmitted SL reservation and the indication of the capability to receive an expected conflict indication, an expected conflict indication from a first UE.
